(19) United States
(12) Patent Application Publication
(10) Pub. No.: US 2026/0242021 A1
(43) Pub. Date: Aug. 20, 2026

(54) HANDLEBAR BAG AND MOUNTING ARRANGEMENT

(71) Applicant: Polaris Industries Inc., Medina, MN (US)

(72) Inventors: Cory Wimpfheimer, Greenbush, MN (US); Cody L. Telford, Sandpoint, ID (US); Barry A. Johnson, Roseau, MN (US); Dale Mangum, Sagle, ID (US)

(21) Appl. No.: 19/542,021

(22) Filed: Feb. 17, 2026

Related U.S. Application Data
(60) Provisional application No. 63/759,708, filed on Feb. 18, 2025.

(51) Int. Cl. B62J 9/21; B62J 9/27

(52) U.S. Cl. CPC B62J 9/21; B62J 9/27

(57) ABSTRACT

A mounted storage bag system includes a mount assembly having at least one lug and a latch post extending outwardly therefrom. The system further includes a bag assembly having at least one supporting surface configured to engage the at least one lug of the mount assembly, and a latch assembly configured to receive the latch post of the mount assembly. The at least one supporting surface is configured to rest on the at least one lug, allowing the bag assembly to pivot relative to the mount assembly. This pivoting movement facilitates selective engagement of the latch post with the latch assembly, providing a secure yet detachable connection between the bag assembly and the mount assembly. The system enables quick attachment and removal of the bag assembly, while ensuring stable retention during use.

### CROSS-REFERENCE TO RELATED APPLICATIONS

This application claims priority to U.S. Provisional Patent Application No. 63/759,708, filed Feb. 18, 2025 and is incorporated herein by reference.

### TECHNICAL FIELD

The present disclosure relates generally to vehicle-mounted storage systems, and more particularly, to a handlebar-mounted bag assembly configured for secure yet detachable attachment to the handlebar of a vehicle, such as a snowmobile, motorcycle, or all-terrain vehicle (ATV).

### BACKGROUND

Storage capacity on vehicles such as snowmobiles is often limited, requiring users to rely on external bags or containers for carrying essential items. Conventional storage solutions, such as strapped or bolted-on saddlebags and cargo boxes, often present challenges related to accessibility, security, and stability, particularly in high-motion environments. These conventional solutions may shift during operation, obstruct vehicle controls, or be cumbersome to remove when not needed. Additionally, existing mounting systems often lack a quick and reliable attachment mechanism, requiring tools for installation or removal, which can be impractical in outdoor and cold-weather conditions.

### SUMMARY

The present disclosure relates to a mounted storage bag system configured for secure yet detachable engagement with a mount assembly. The system includes a bag assembly having at least one supporting surface configured to engage a lug of the mount assembly and a latch assembly for selective engagement with a latch post extending from the mount assembly. The supporting surface is structured to rest on the lug, allowing the bag assembly to pivot relative to the mount assembly, thereby facilitating controlled alignment and securement of the latch assembly to the latch post.

In operation, a user positions the mounted storage bag system onto the lugs of the clamp mount assembly, where the supporting surface resides within a ridge defined on the lugs, ensuring initial stability before final engagement. The ridge dimensions may be configured such that the ridge size is larger than the supporting surface thickness, thereby aiding in alignment and allowing the bag to naturally settle into place. Upon positioning, the bag assembly pivots about the supporting surface, guiding the latch post into the latch post aperture of the latch assembly. In some embodiments, the weight of the bag alone causes automatic securement, while in other embodiments, an external force may be required to ensure full engagement, which can momentarily apply a bending load to the bag mount assembly during securement. Additionally, in some embodiments, the latch post or a portion of the latch assembly is magnetized, allowing magnetic attraction between the latch post and latch assembly to aid in alignment and actively pull the latch post into the latch assembly, thereby improving engagement reliability and reducing the need for precise manual positioning.

Once the latch post is received within the latch assembly, a movable latch engages a latch ridge defined on the latch post, securing the bag assembly in place. Engagement may be accompanied by audible and haptic feedback, such as a click sound, which can be heard through a helmet, and resistance feedback, confirming secure attachment. The bag assembly is then retained in a preloaded position against the support, ensuring a wiggle-free fit that reduces unintended movement, vibrations, and noise during operation.

In embodiments where external force is applied to facilitate securement, the bag mount assembly may remain in a loaded state until the latch assembly is released. Upon release of the latch assembly, the stored preload force returns the bag mount assembly to an unloaded state, facilitating controlled separation of the latch post from the latch assembly. To remove the bag assembly, the user actuates a latch handle, disengaging the movable latch from the latch ridge, thereby releasing the latch post from the latch assembly. The bag assembly can then pivot slightly on the lugs, allowing for smooth detachment, after which the user may fully lift and remove the bag assembly from the mount assembly.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of this description, illustrate various aspects of the present disclosure. A brief description of the drawings is as follows:

FIG. 1 shows a perspective view of a snowmobile upon which a handlebar bag assembly may be mounted.

FIG. 2 shows an alternate perspective view of the snowmobile of FIG. 1

FIG. 3 shows a front view of the snowmobile of FIG. 1.

FIG. 4 shows a rear view of the snowmobile of FIG. 1.

FIG. 5 shows a top view of the snowmobile of FIG. 1.

FIG. 6 shows an exploded view of the snowmobile of FIG. 1.

FIG. 7 shows a perspective view of a handlebar bag assembly.

FIG. 8 shows an exploded, perspective view of the handlebar bag assembly of FIG. 7.

FIG. 9 shows a left side view of the handlebar bag assembly of FIG. 7.

FIG. 10 shows a right-side view of the handlebar bag assembly of FIG. 7.

FIG. 11 shows a perspective view of a snowmobile with the handlebar bag assembly of FIG. 7 mounted thereon.

FIG. 12 shows an alternate perspective view of the snowmobile of FIG. 11.

FIG. 13 shows a rider's perspective view of the snowmobile of FIG. 11.

FIG. 14 shows a top view of the snowmobile of FIG. 11.

FIG. 15 shows a perspective view of an forward-facing bag assembly, as a component of the handlebar bag assembly of FIG. 7.

FIG. 16 shows a top view of a forward-facing bag assembly, in accordance with an embodiment of the disclosure.

FIG. 17 shows a perspective view of a forward-facing bag assembly, in accordance with an embodiment of the disclosure.

FIG. 18 shows a rear view of the forward-facing bag assembly of FIG. 17.

FIG. 19 shows an exploded, perspective view of the forward-facing bag assembly of FIG. 17.

FIG. 20 shows a perspective view of an interior of the forward-facing bag assembly of FIG. 17.

FIG. 21 shows a perspective view of an aft-facing bag assembly, as a component of the handlebar bag assembly of FIG. 7.

FIG. 22 shows a front view of the aft-facing bag assembly of FIG. 21.

FIG. 23 shows a rear view of the aft-facing bag assembly of FIG. 23.

FIG. 24 shows a perspective view of an aft-facing bag assembly, in accordance with an embodiment of the disclosure.

FIG. 25 shows a rear view of the aft-facing bag assembly of FIG. 24.

FIG. 26 shows an exploded, perspective view of the aft-facing bag assembly of FIG. 24.

FIG. 27 shows a perspective view of an interior of the aft-facing bag assembly of FIG. 24.

FIG. 28 shows an exploded, perspective view of a mount assembly, as a component of the handlebar bag assembly of FIG. 7.

FIG. 29 shows a top view of a support component of the mount assembly of FIG. 28.

FIG. 30 shows a profile view of the support component of FIG. 28.

FIG. 31 shows a perspective view of the support component of FIG. 28.

FIG. 32 shows a perspective view of the bag mount assembly of FIG. 28.

FIG. 33 shows an exploded, perspective view of a mount assembly, as a component of the handlebar bag assembly of FIG. 7.

FIG. 34 shows a perspective view of the hangar assembly of FIG. 33.

FIG. 35 shows an exploded, perspective view of the mount assembly of FIG. 34 including hubs and latch posts.

FIG. 36 shows a perspective view of the mount assembly of FIG. 35.

FIG. 37 shows a perspective, cross-sectional view featuring the latch posts of the mount assembly of FIG. 36.

FIG. 38 shows an orthogonal, cross-sectional view of the mount assembly of FIG. 37.

FIG. 39 shows a perspective, cross-sectional view featuring the hubs of the mount assembly of FIG. 36.

FIG. 40 shows an orthogonal, cross-sectional view of the hubs of FIG. 39.

FIG. 41 shows a profile view of the mount assembly of FIG. 36.

FIG. 42 shows a perspective view of a mount assembly and handlebar mount assembly, as components of the handlebar bag assembly of FIG. 7.

FIG. 43 shows a perspective, cross-sectional view of the mount assembly and handlebar mount assembly of FIG. 42.

FIG. 44 shows an orthogonal, cross-sectional view of the mount assembly and handlebar mount assembly of FIG. 43 in a first position.

FIG. 45 shows an orthogonal, cross-sectional view of the mount assembly and handlebar mount assembly of FIG. 43 in a second position.

FIG. 46 shows a perspective, cross-sectional view of the mount assembly and handlebar mount assembly of FIG. 42.

FIG. 47 shows an orthogonal, cross-sectional view of the mount assembly and handlebar mount assembly of FIG. 46 with a movable latch in a first position.

FIG. 48 shows an orthogonal, cross-sectional view of the mount assembly and handlebar mount assembly of FIG. 46 with a movable latch in a second position.

FIG. 49 shows an orthogonal, cross-sectional view featuring the latch posts of the handlebar bag assembly of FIG. 7.

FIG. 50 shows an orthogonal, cross-sectional view featuring the lugs of the handlebar bag assembly of FIG. 7.

FIG. 51 shows a cross-sectional view featuring pivoting of a bag about the lugs of the handlebar bag assembly of FIG. 7.

FIG. 52 shows a detailed view of the lugs and the support of FIG. 51.

FIG. 53 shows a cross-sectional view featuring a connection of the latch assembly with the latch post of the handlebar bag assembly of FIG. 7.

FIG. 54 shows a first configuration of a bag mount assembly.

FIG. 55 shows a second configuration of a bag mount assembly.

FIG. 56 shows a third configuration of a bag mount assembly.

FIG. 57 shows a plan view of a bag mount assembly according to the first configuration of FIG. 54

FIG. 58 shows a fourth configuration of a bag mount assembly.

FIG. 59 shows a profile view of the fourth configuration of FIG. 58.

### DETAILED DESCRIPTION

Reference will now be made in detail to exemplary aspects of the present disclosure that are illustrated in the accompanying drawings.

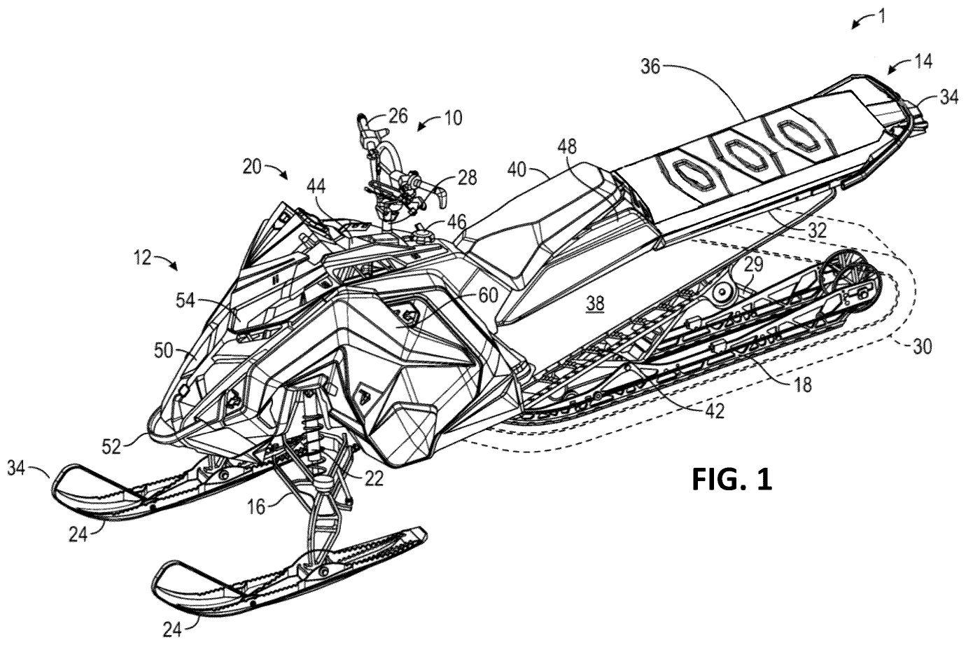

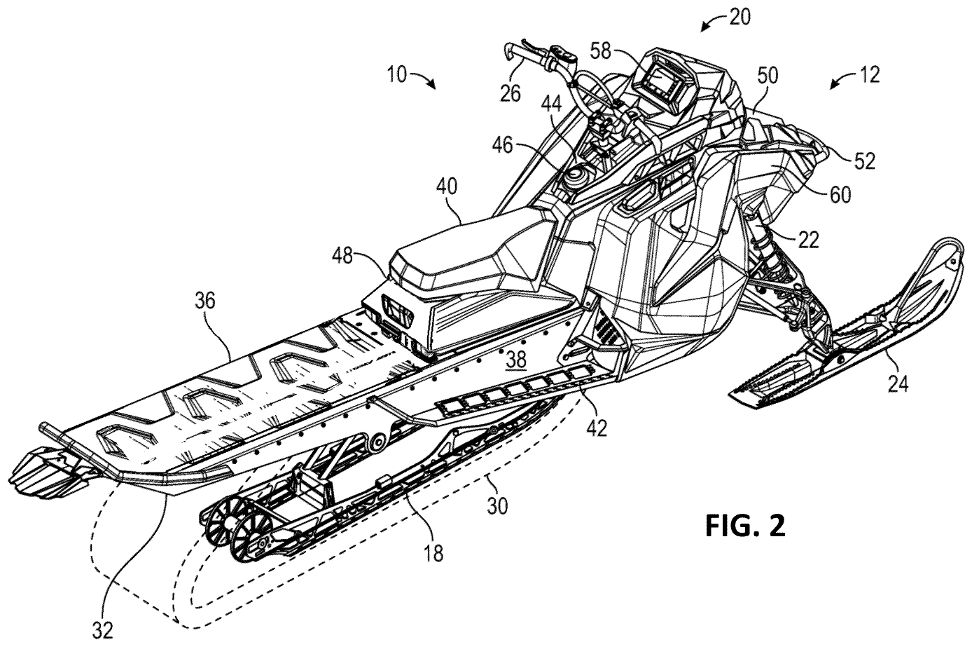

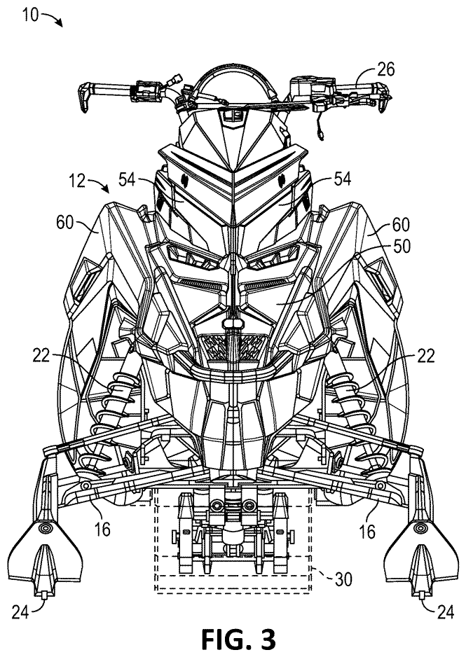

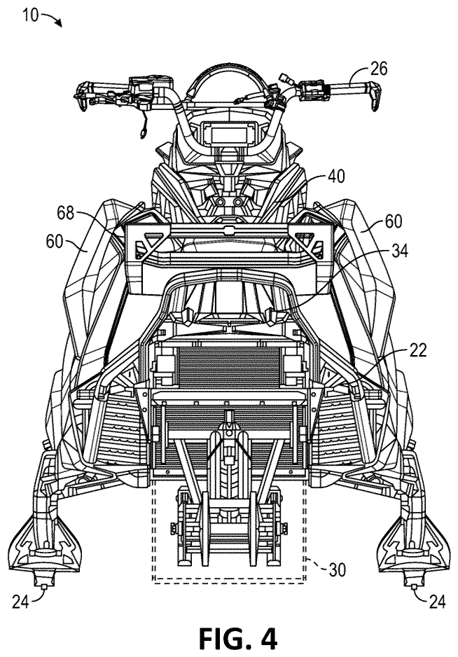

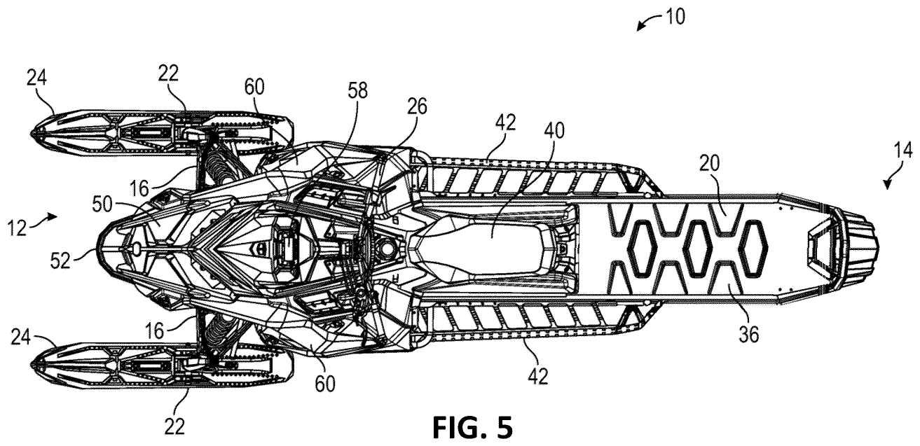

With reference to FIGS. 1-6, an exemplary vehicle in accordance with the present disclosure is illustrated. Although the vehicle is illustrated as a snowmobile 10, it will be appreciated that numerous aspects of the present disclosure may be implemented in any other suitable vehicle. The snowmobile 10 may be any suitable type of snowmobile, including, but not limited to, a trail snowmobile, sport trail snowmobile, touring snowmobile, performance snowmobile, utility snowmobile (such as a snowmobile suitable for search and rescue, law enforcement, military operations, etc.), crossover snowmobile, mountain snowmobile, or youth snowmobile.

The snowmobile 10 generally includes a front end 12 and a rear end 14. At the front end 12, a front suspension 16 is provided. At the rear end 14, a rear suspension 18 is provided. The front suspension 16 and the rear suspension 18 support a chassis 20, which serves as the structural framework for the snowmobile.

The front suspension 16 includes one or more shock absorbers 22, each of which is operably coupled to a ski 24. The shock absorbers 22 may be any suitable dampening device configured to absorb shock resulting from the skis 24 traversing uneven terrain. The skis 24 are configured to engage a ground surface and facilitate movement of the snowmobile 10 over snow and other surfaces. Steering of the skis 24 is accomplished, at least in part, via a steering device, which may include a handlebar 26 operably coupled to a steering rod 28.

The rear suspension 18 is operably coupled to a track 30, which may be an endless or continuous belt. Rotation of the track 30 facilitates propulsion of the snowmobile 10. The track 30 is circulated through a tunnel 32, which is at least partially defined by the chassis 20. In certain embodiments, the tunnel 32 may be tapered at the rear end 14 to enhance aerodynamics or accommodate specific operational configurations. A flap 34 is positioned at the rear end 14 and is configured to reduce or block snow and other debris from being projected upward by the track 30 during operation.

Mounted to the chassis 20 and positioned atop the tunnel 32 is a seat 40, which is configured to accommodate an operator of the snowmobile 10. On both sides of the chassis 20 or the tunnel 32, one or more footrests 42 are provided to support the feet of the operator while seated on the seat 40. The seat 40 is positioned to allow the operator to grasp the handlebars 26 for steering the snowmobile 10. The handlebars 26 are operably coupled to the steering rod 28, which protrudes from within a center console 44. A fuel cap 46 is provided on the center console 44 to allow access to a fuel tank 48, which is configured to store fuel for the operation of the snowmobile 10.

An accessory mounting area 36 is provided, which may be positioned beneath the seat 40 or behind the seat 40 on the chassis 20. A rear accessory mount 38 is also provided, allowing for the attachment of one or more accessories to the snowmobile 10. Suitable accessories may include, but are not limited to, a storage container, a secondary seat, a fuel tank, an oil tank, a chainsaw mount, a snowboard rack, an ice auger mount, a ski mount, and/or a gun scabbard.

At the front end 12, a hood assembly 50 is mounted atop a nose pan. The hood assembly 50 may house one or more headlights 54, which are configured to provide illumination for operation in low-light conditions. An optional windshield 56 may be provided at an upper portion of the hood assembly 50 to reduce wind resistance and protect the operator. A display 58 is associated with the hood assembly 50 and is configured to present operational and performance-related information to the operator. The hood assembly 50 further includes one or more body panels 60, which may be interchangeable to facilitate customization, maintenance, or replacement. A front bumper 52 is positioned at a forward portion of the hood assembly 50 and is configured to provide impact resistance.

A light assembly 62 is positioned near the rear end 14 of the snowmobile 10. The light assembly 62 may function as a brake light assembly, a tail lamp assembly, a work light, or any combination thereof. A rack platform 66 may be operably coupled to the chassis 20 and is configured to support additional cargo or equipment for transport.

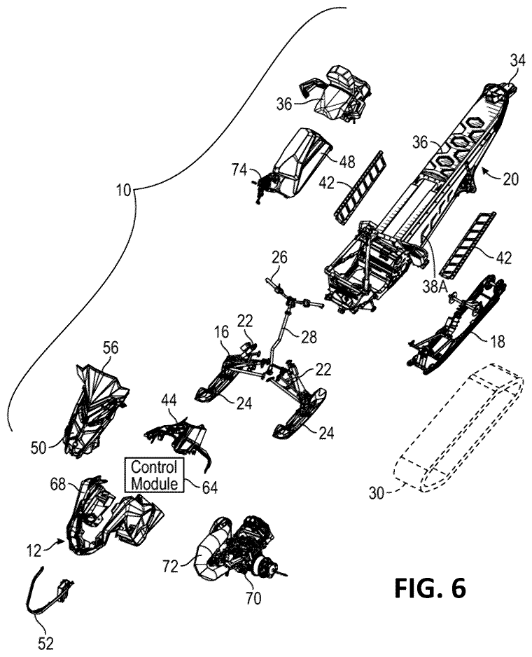

With particular reference to FIG. 6, the snowmobile 10 includes an engine assembly 70 configured to generate power for propelling the snowmobile 10. The engine assembly 70 may be implemented in various configurations, including, but not limited to, a two-stroke engine, a four-stroke engine, or a turbocharged engine. The engine assembly 70 is operably coupled to an exhaust assembly 72, which is configured to manage exhaust gases produced during operation. Lubrication for the engine assembly 70 may be facilitated by an oil tank assembly 74, which may be positioned proximate to the seat 40.

The snowmobile 10 further includes a control module 64, which may be arranged at any suitable location, such as within the hood assembly 50 or beneath the center console 44. In some embodiments, the control module 64 may be incorporated with the display 58 or integrated into a control assembly mounted to the handlebars 26. The control module 64 may be configured to manage various operational functions of the snowmobile 10, including, but not limited to, engine performance, lighting, suspension adjustments, and other vehicle control parameters.

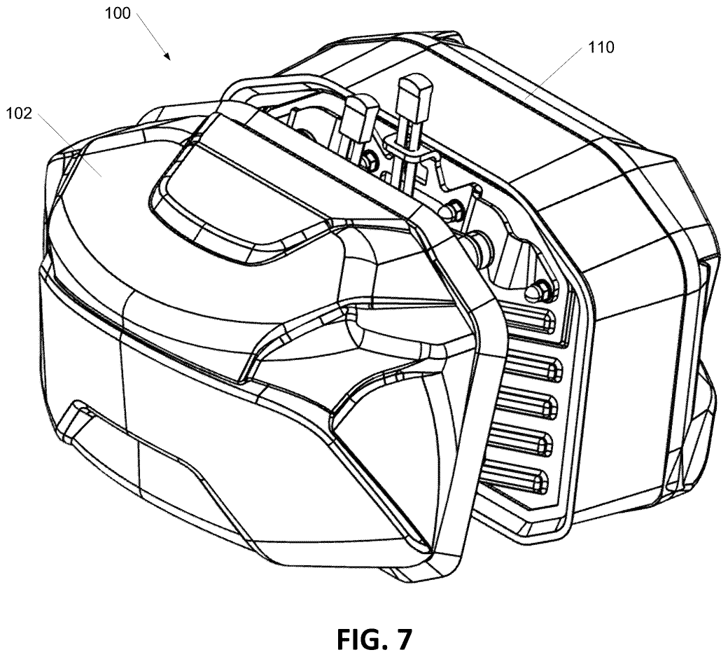

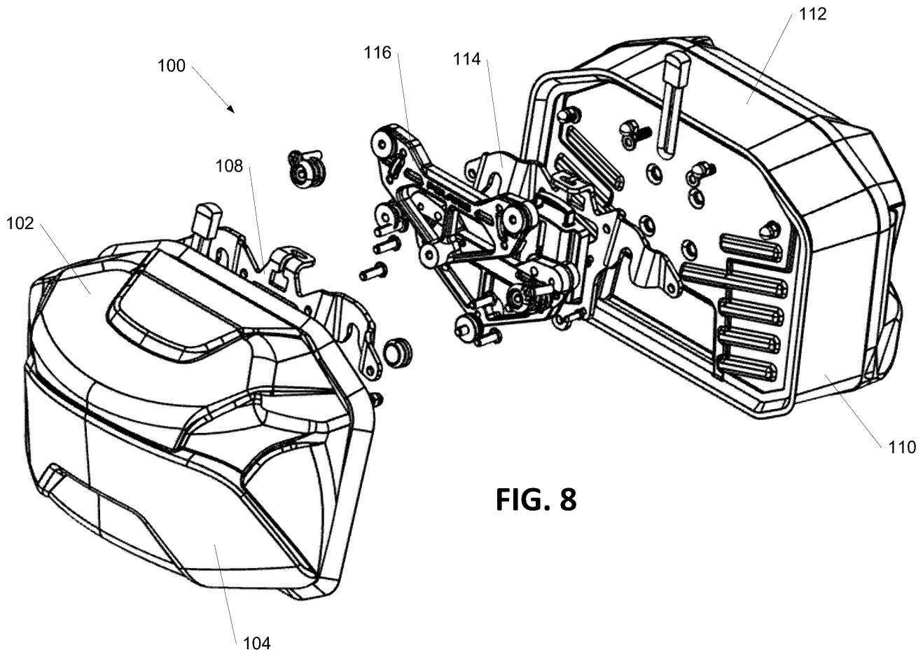

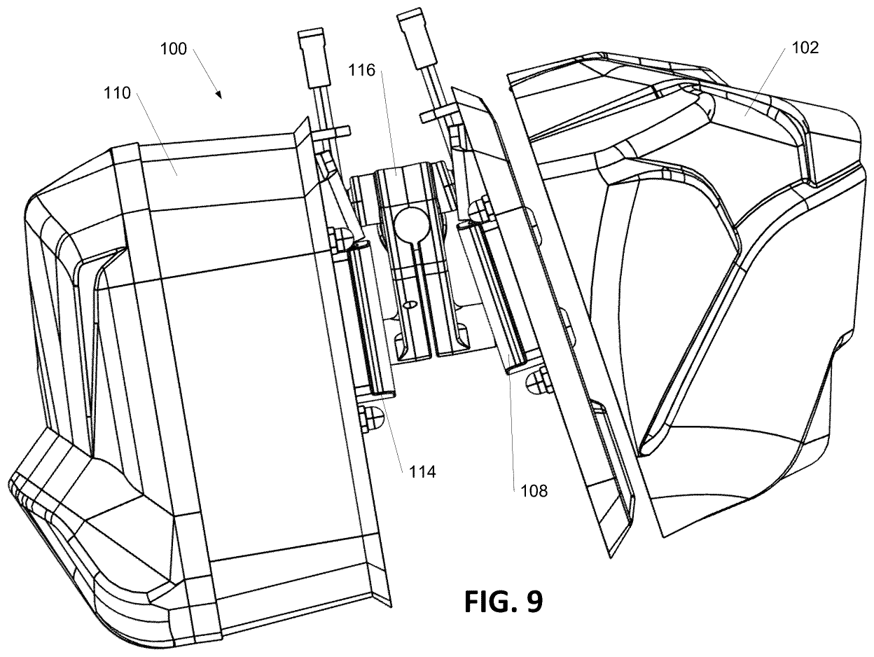

With reference to FIGS. 7-10, an example mounted storage bag system 100 is illustrated in accordance with an embodiment of the present disclosure. The mounted storage bag system 100 is configured to be attached to a steering mechanism of a vehicle, such as the handlebars 26 of a snowmobile 10. The mounted storage bag system 100 is structured to provide additional storage capacity while maintaining accessibility and minimizing interference with vehicle operation.

As depicted, the mounted storage bag system 100 can include a first, forward-facing bag assembly 102 and a second, aft-facing bag assembly 110, each operably coupled to a clamp mount assembly 116. The forward-facing bag assembly 102 can include a forward-facing bag 104 and a bag mount assembly 108, wherein the forward-facing bag 104 is oriented in a forward-facing direction relative to the vehicle. Similarly, the aft-facing bag assembly 110 can include an aft-facing bag 112 and a bag mount assembly 114, wherein the aft-facing bag 112 is oriented toward the operator when the mounted storage bag system 100 is mounted to the vehicle. The bag mount assemblies 108, 114 facilitate attachment of the forward-facing bag assembly 102 and the aft-facing bag assembly 110 to the clamp mount assembly 116, which, in turn, is coupled to the handlebars 26 of the snowmobile 10 or another suitable vehicle.

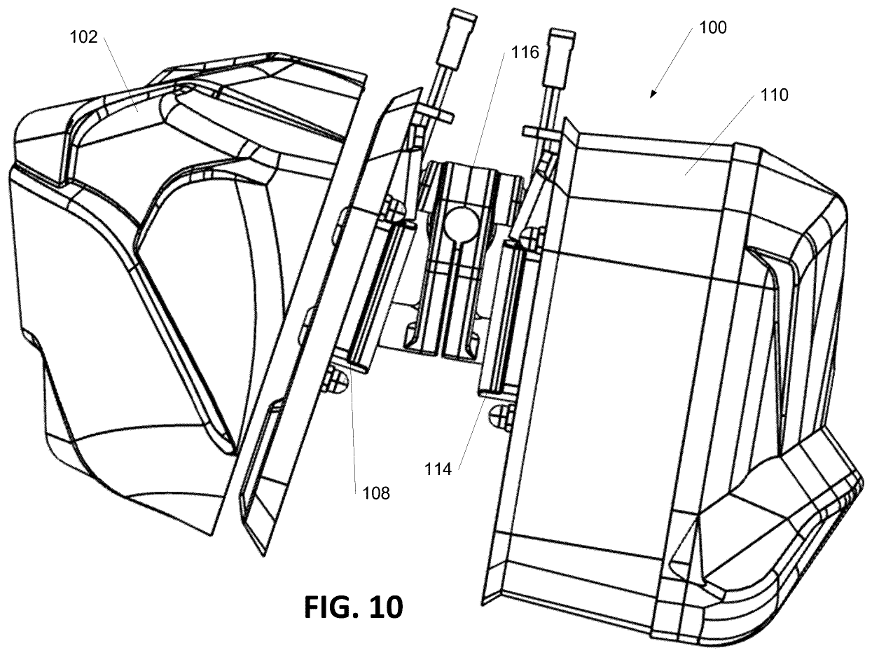

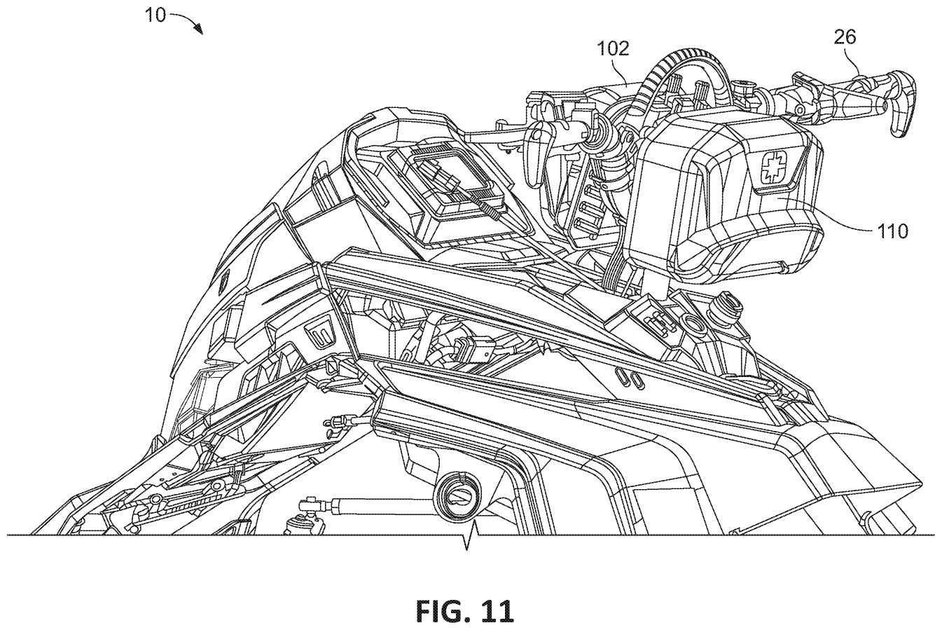

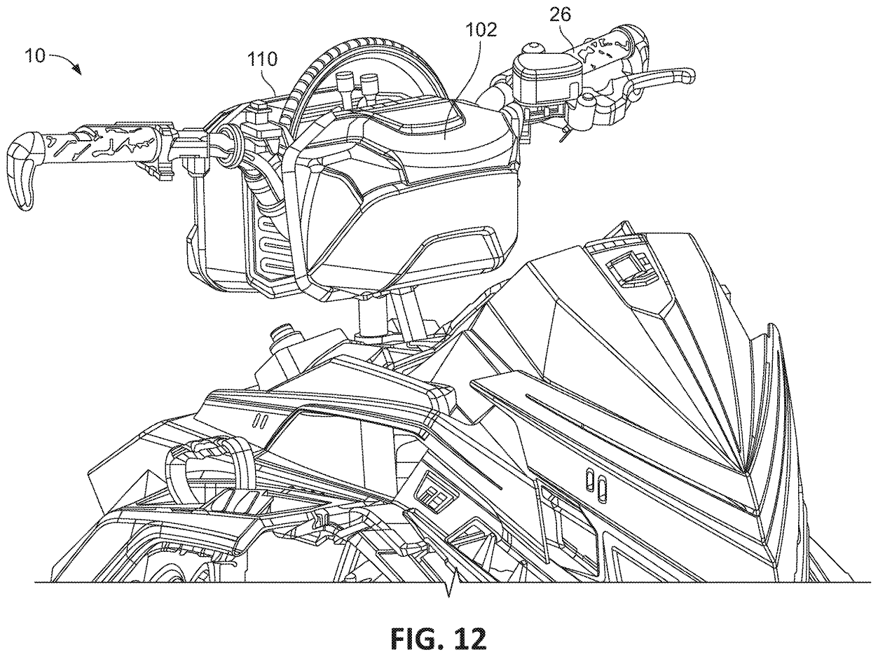

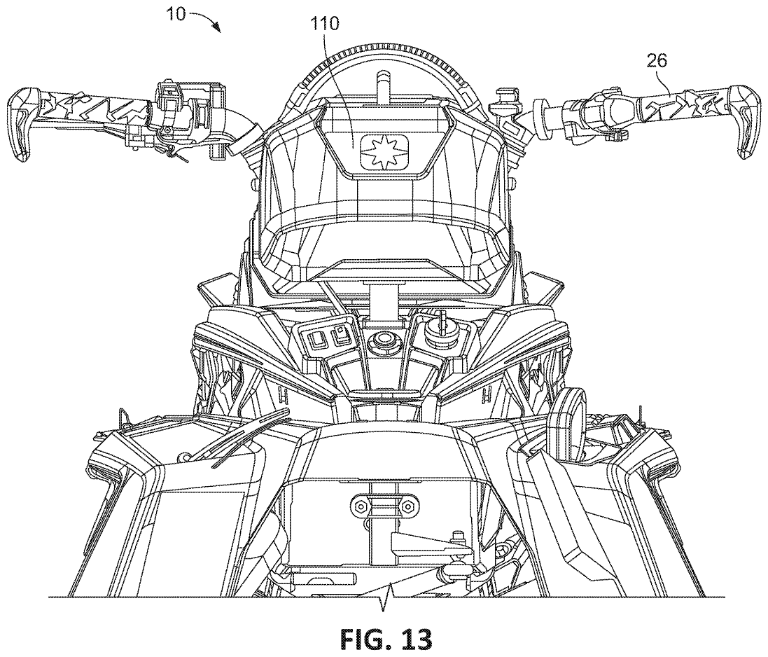

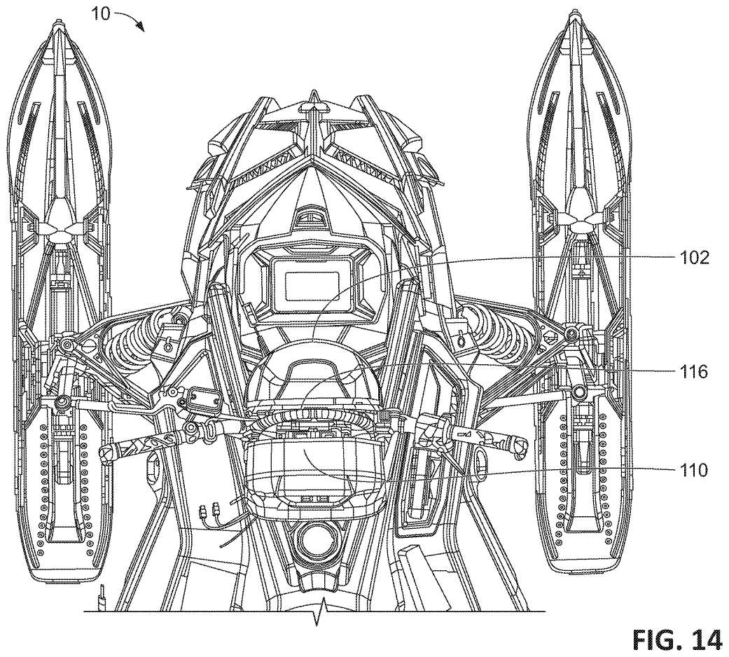

With additional reference to FIGS. 11-14, the mounted storage bag system 100 is illustrated in a mounted configuration, wherein the clamp mount assembly 116 is secured to the handlebars 26 of the snowmobile 10. As further detailed below, the clamp mount assembly 116 can be configured to secure to the handlebars 26. In other embodiments, portions of the clamp mount assembly 116 may be integrated directly into the handlebars 26 or another portion of the snowmobile 10, thereby forming a permanent mounting interface for the mounted storage bag system 100 or other accessory.

The forward-facing bag assembly 102 and the aft-facing bag assembly 110 are selectively secured to the clamp mount assembly 116, thereby enabling attachment and removal of the bag assemblies 102, 110 along with their respective contents. The bag mount assemblies 108, 114 facilitate engagement with corresponding passive mounting components on the clamp mount assembly 116, which can include one or more lugs and a latch post. For example, in one embodiment, the bag mount assemblies 108, 114 can be configured to rest on the lugs, enabling pivotal movement of the bag assemblies 102, 110 as the latch post is guided into a latch assembly of each bag assembly. In some embodiments, all active components, such as a movable latch and latch handle (which are described in greater detail below), are located on the bag assemblies 102, 110, while the clamp mount assembly 116, which contains only passive mounting components, remains fixed to the handlebars 26.

While the forward-facing bag assembly 102 and the aft-facing bag assembly 110 are depicted as having different shapes and sizes to accommodate various storage requirements, the bag mount assemblies 108, 114 can be substantially identical, thereby enabling interchangeable positioning of the bag assemblies 102, 110 on the clamp mount assembly 116. This interchangeability facilitates user customization based on storage preferences and vehicle configuration, providing a modular and adaptable storage solution for various applications.

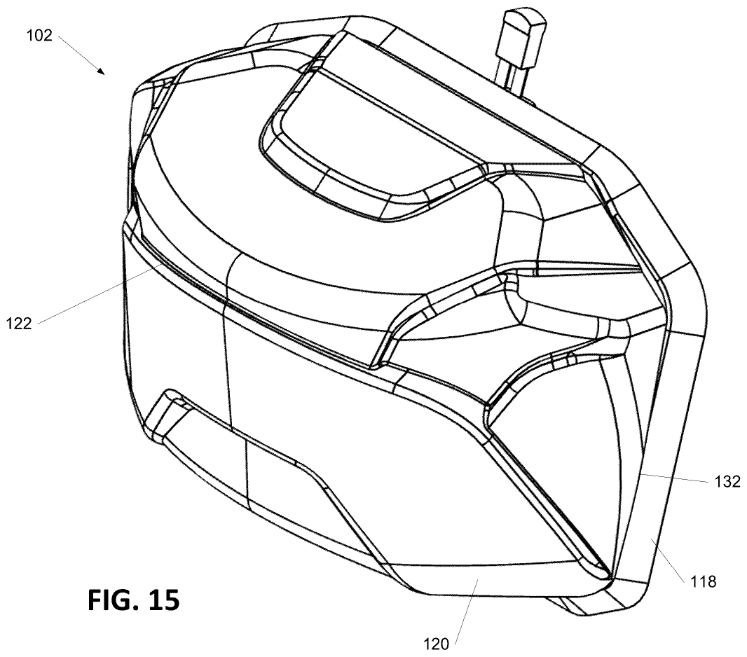

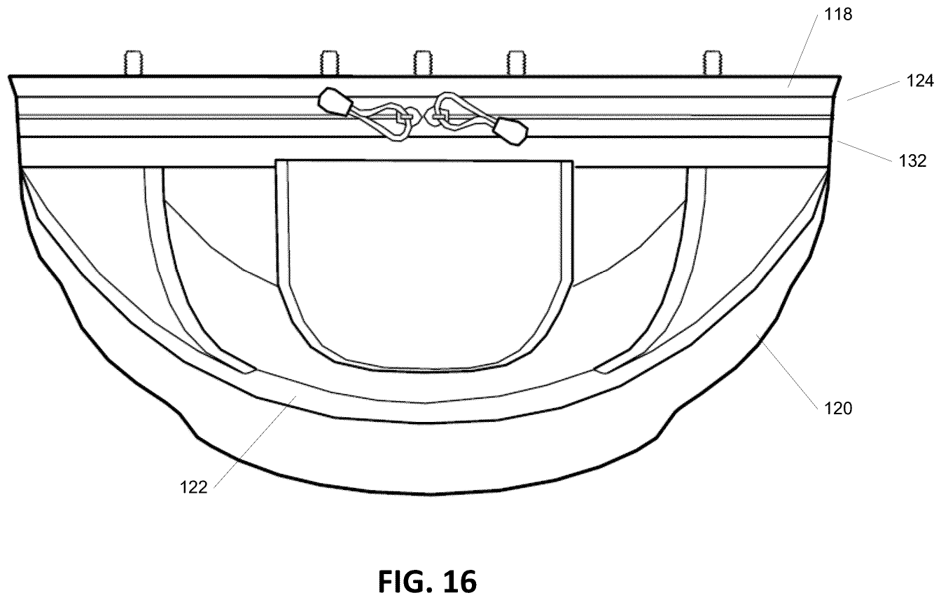

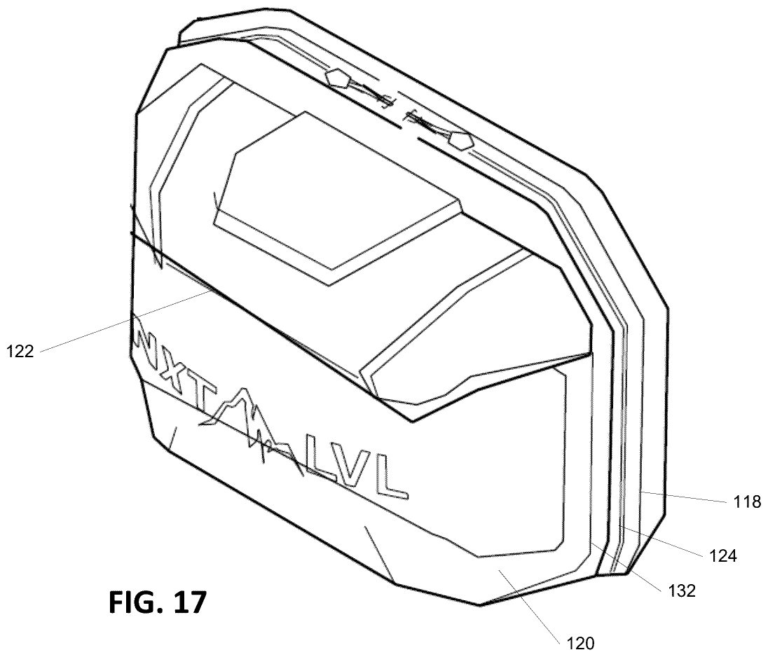

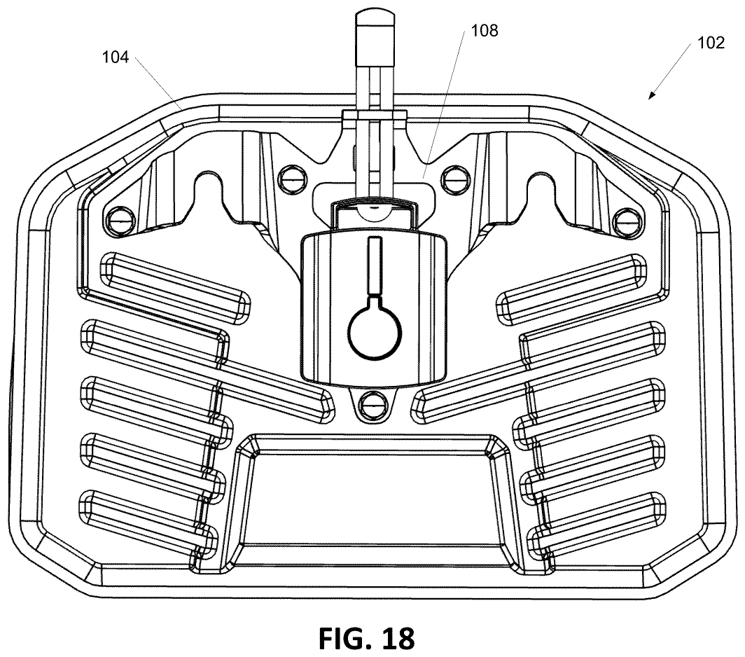

With reference to FIGS. 15-20, a forward-facing bag assembly 102 is depicted in accordance with embodiments of the present disclosure. The forward-facing bag assembly 102 includes a forward-facing bag 104 and a bag mount assembly 108, which are configured to attach to the clamp mount assembly 116 and provide additional storage capacity while maintaining accessibility for the operator. The forward-facing bag 104 is oriented away from the rider when mounted to a vehicle, such as a snowmobile 10, and is structured to retain its shape while withstanding operational stresses encountered during use. In some embodiments, the forward-facing bag 104 is specifically shaped and dimensioned to store a pair of goggles, with internal compartmentalization to facilitate secure placement and retrieval of the goggles while mitigating movement during vehicle operation.

As depicted, in some embodiments, the forward-facing bag 104 can include a base panel 118 and a contour panel 120, which together define a sealed three-dimensional storage interior. The base panel 118 can be substantially rigid and may be constructed from high-density polyethylene (HDPE), injection-molded polyurethane, or other thermoformed plastics to provide structural integrity while maintaining lightweight properties. The base panel 118 may further define a plurality of structural ridges 122, which can be formed as bent ridges in a uniform-thickness stock material to enhance rigidity. The contour panel 120 may define a perimeter ridge 124, which can be coupled to the base panel 118.

The contour panel 120 is coupled to the base panel 118, with a perimeter 132 of the contour panel 120 attaching to the perimeter ridge 124 of the base panel 118, thereby forming an enclosed three-dimensional storage compartment. The contour panel 120 may define one or more access flaps, which can be secured using a zipper 136, magnetic coupling, or other suitable closure mechanisms, enabling selective access to the interior storage space. In some embodiments, the zipper 136 can be a TPU-coated zipper to provide enhanced water resistance. The interior compartment of the forward-facing bag 104 may include expanded polyethylene (EPE) foam padding to enhance protection for stored items and mitigate the transmission of external shocks.

One or more structural ridges 122 or other reinforcement features may be incorporated into the contour panel 120 to enhance aesthetics, rigidity, and overall durability, while aligning with the design characteristics of the snowmobile 10. Additionally, in some embodiments, the forward-facing bag 104 can include neoprene or EVA foam reinforcements at high-stress locations, such as hinge points or closure interfaces, to provide additional wear resistance and mechanical cushioning. The contour panel 120 can be substantially rigid and may be formed using TPU-coated polyester, TPU-coated nylon, or similar polymer-laminated textile materials, thereby providing a balance of durability, flexibility, and water resistance.

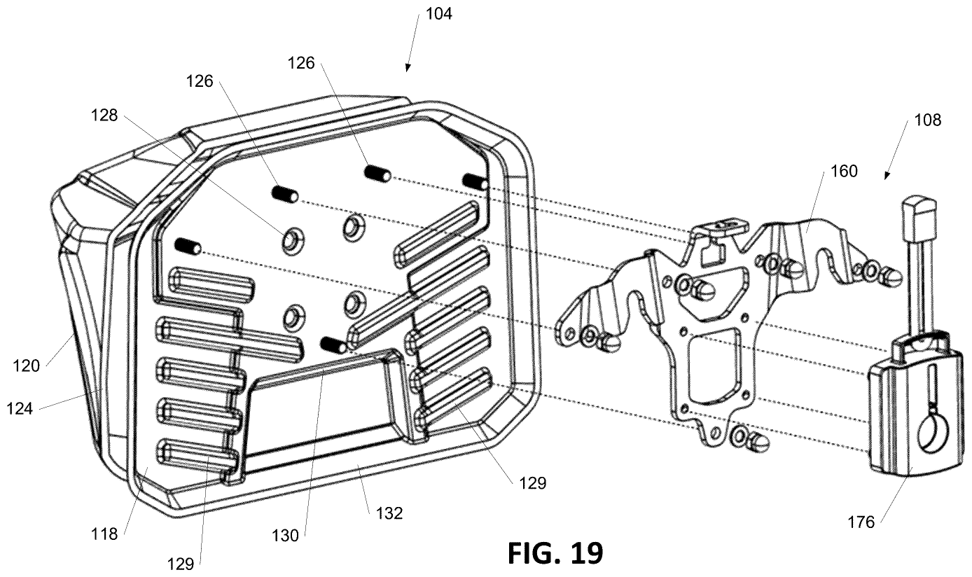

As best depicted in FIG. 19, the base panel 118 can define a plurality of fasteners 126 (e.g., five fasteners) extending outwardly for secure attachment to the bag mount assembly 108, as well as one or more recesses 128 configured to receive portions of the bag mount assembly 108 to facilitate a stable connection. In some embodiments, a base panel handle 130 is integrated into the base panel 118 to aid in manipulation and handling of the forward-facing bag 104.

As best depicted in FIG. 20, in some embodiments, the forward-facing bag 104 can define a plurality of compartments 134, which can be used to organize and secure various items within the storage space. Additionally, one or more retention straps 138 can be positioned within the interior of the forward-facing bag 104. The retention strap 138 can be formed from polypropylene webbing, folded elastic, or knit fabric with TPU coatings and is structured to limit the motion of a portion of the bag, thereby functioning as a supporting shelf when the bag is in an open configuration, which can serve to inhibit the unintended displacement of stored contents (e.g., preventing stored items such as goggles or accessories from falling out when the access flap is open).

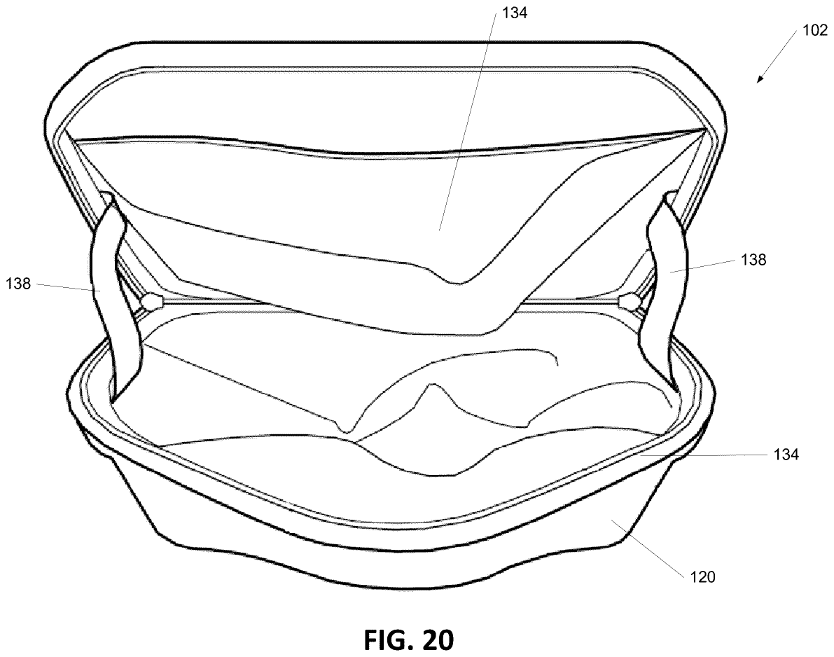

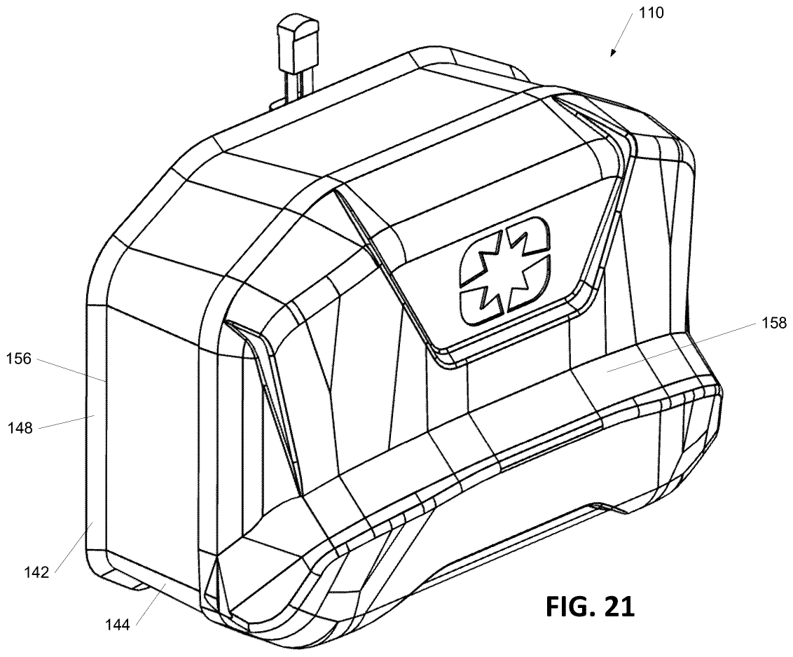

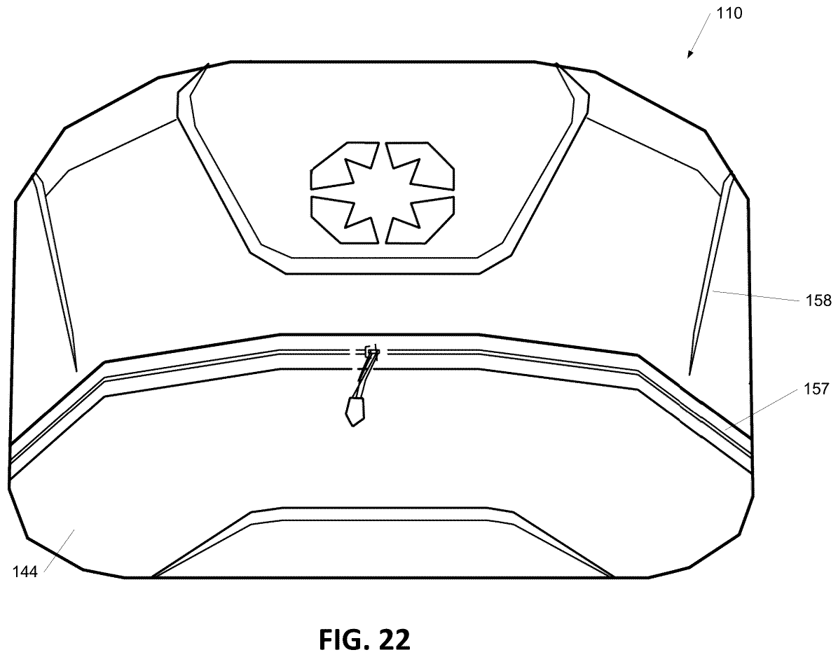

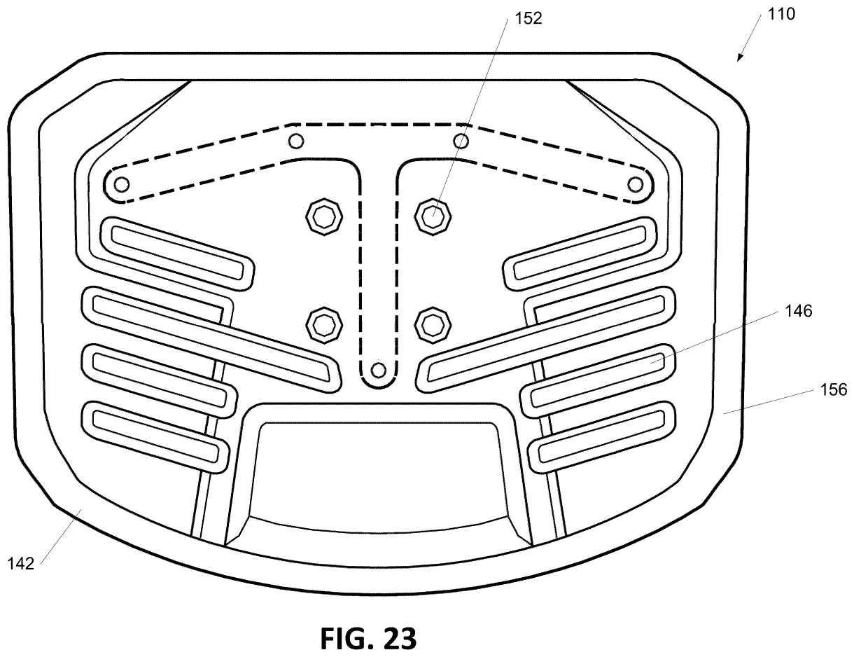

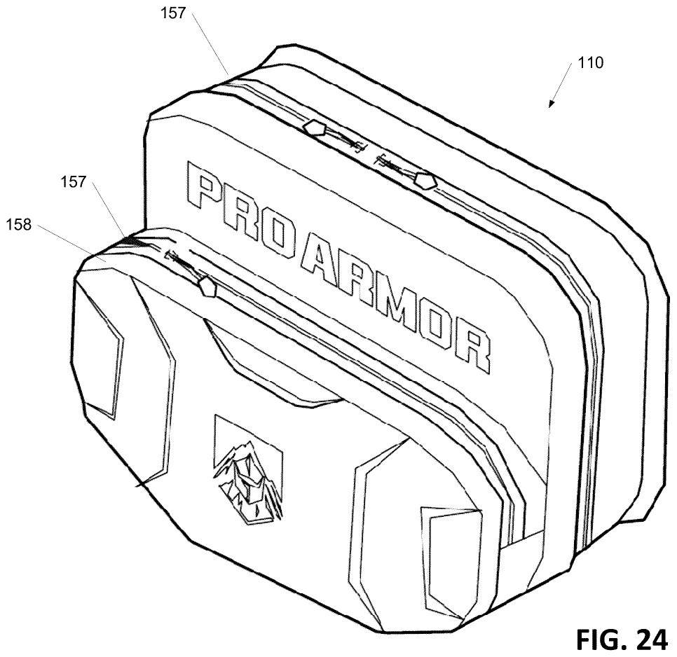

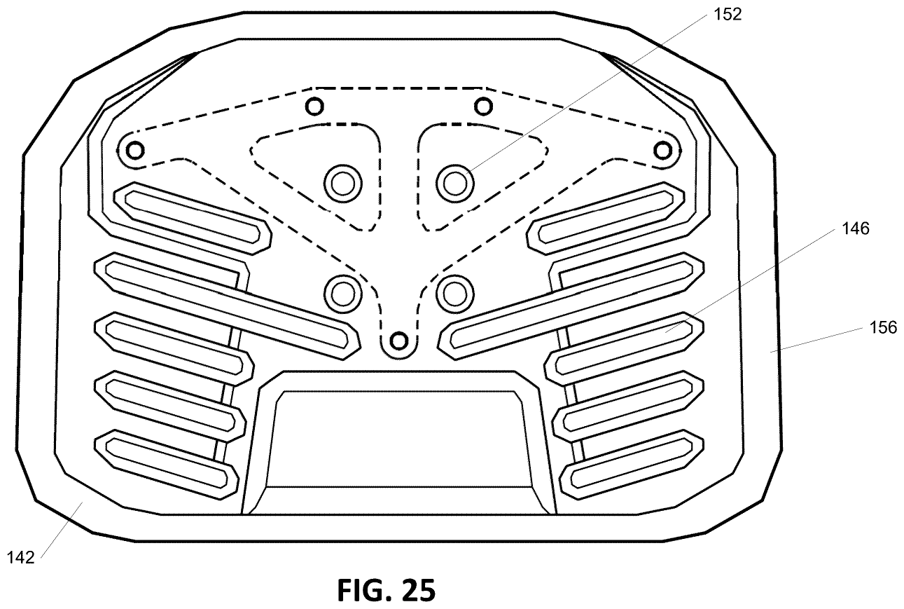

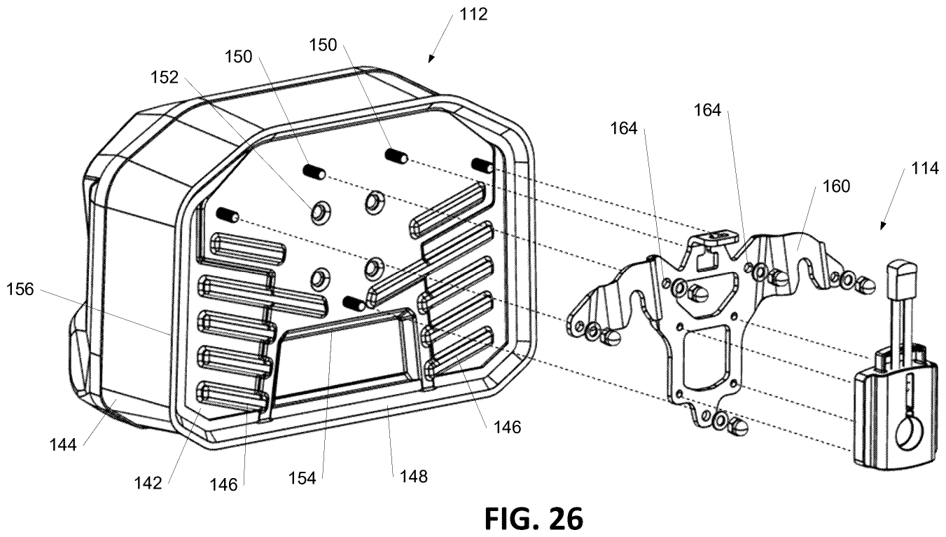

With reference to FIGS. 21-27, an aft-facing bag assembly 110 is illustrated. The aft-facing bag assembly 110 includes an aft-facing bag 112 and a bag mount assembly 114, which are configured to attach to the mounted storage bag system 100 and provide additional storage capacity while minimizing interference with the operation of the vehicle. The aft-facing bag 112 is oriented toward the rider when mounted to a vehicle, such as a snowmobile 10, and is structured to generally retain its shape while withstanding operational stresses encountered during use. In some embodiments, the aft-facing bag 112 is specifically shaped and dimensioned to accommodate commonly used equipment, including but not limited to a portable saw, water, snacks, or other compact tools, with internal compartmentalization designed to facilitate secure placement and prevent displacement of stored items during vehicle operation.

The aft-facing bag 112 includes a base panel 142 and a contour panel 144, which together define a sealed three-dimensional storage interior. The base panel 142 can be substantially rigid and may be constructed from high-density polyethylene (HDPE), injection-molded polyurethane, thermoformed plastic, or other structural polymers to provide mechanical strength and impact resistance. The base panel 142 may further define a plurality of structural ridges 146, which can be formed as bent ridges, molded reinforcements, or integrally formed raised sections to enhance rigidity, load distribution, and dimensional stability. Additionally, a perimeter ridge 148 may extend outwardly from the contour panel 144, for example, toward the bag mount assembly 114, providing increased structural reinforcement.

The base panel 142 can further define a plurality of fasteners 150 (e.g., five fasteners) extending outwardly for secure attachment to the bag mount assembly 114, as well as one or more recesses 152 configured to receive portions of the bag mount assembly 114 to facilitate a stable and secure connection. In some embodiments, a base panel handle ridge 154 is integrated into the base panel 142 to aid in manipulation and handling of the aft-facing bag 112.

The contour panel 144 can be substantially rigid and may be formed using TPU-coated polyester, TPU-coated nylon, knit fabric with TPU coatings, or similar polymer-laminated textile materials, thereby providing a balance of durability, flexibility, and water resistance. The contour panel 144 is coupled to the base panel 142, with a perimeter 156 of the contour panel 144 attaching to the perimeter ridge 148 of the base panel 142, thereby forming an enclosed three-dimensional storage compartment.

The contour panel 144 may define one or more access flaps, which can be secured using a zipper 157, magnetic coupling, or other suitable closure mechanisms, enabling selective access to the interior storage space. In some embodiments, the zipper 157 is positioned on the contour panel 144 and can be a TPU-coated zipper to provide enhanced water resistance and abrasion resistance. The interior compartment of the aft-facing bag 112 may include expanded polyethylene (EPE) foam padding to enhance protection for stored items and mitigate the transmission of external shocks.

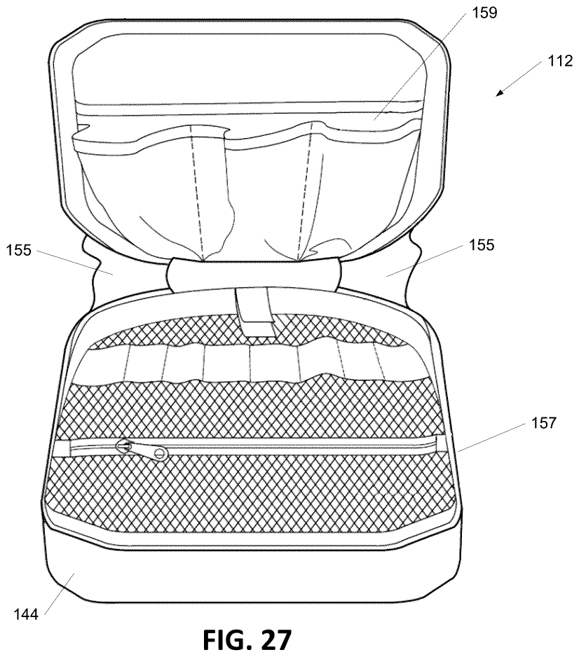

As best depicted in FIG. 27, in some embodiments, the forward-facing bag 104 can define a plurality of compartments 159, which can be configured to organize and secure various items within the storage space. Additionally, a limiting web 155 can be positioned within the interior of the forward-facing bag 104. The limiting web 155 can be formed from polypropylene webbing, folded elastic, or TPU-coated knit fabric and is structured to limit the motion of a portion of the bag, thereby functioning as a supporting shelf when the bag is in an open configuration. This configuration inhibits the unintended displacement of stored contents (e.g., preventing stored items such as tools, water bottles, or accessories from falling out when the access flap is open). In some embodiments, the limiting web 155 is adjustably secured using hook-and-loop fasteners, buckles, or other adjustable mechanisms, allowing the user to customize the extent of the opening limitation.

One or more structural ridges 158 or other reinforcement features may be incorporated into the contour panel 144 to enhance aesthetics, rigidity, and overall durability, while aligning with the design characteristics of the snowmobile 10. Additionally, in some embodiments, the aft-facing bag 112 can include neoprene or EVA foam reinforcements at high-stress locations, such as hinge points or closure interfaces, to provide additional wear resistance and mechanical cushioning. As depicted, the aft-facing bag 112 can generally be larger in volume than the forward-facing bag 104, with a complex polygonal shape incorporating multiple curved surfaces to optimize storage capacity while minimizing interference with other components of the snowmobile 10.

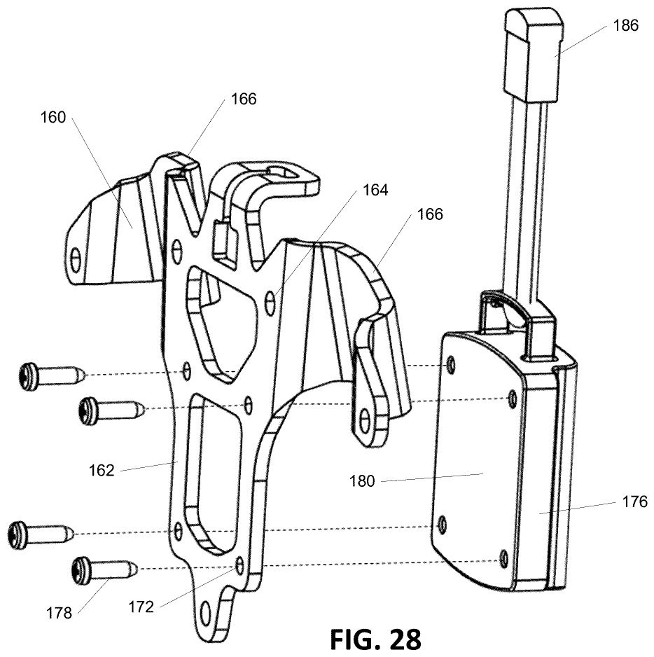

With reference to FIGS. 28-32, a bag mount assembly 108 is depicted. For discussion purposes, the bag mount assembly 108 is described in detail; however, it will be understood that the bag mount assembly 114 is substantially identical, includes the same features, and is interchangeable with the bag mount assembly 108. Accordingly, the description of the bag mount assembly 108 equally applies to the bag mount assembly 114.

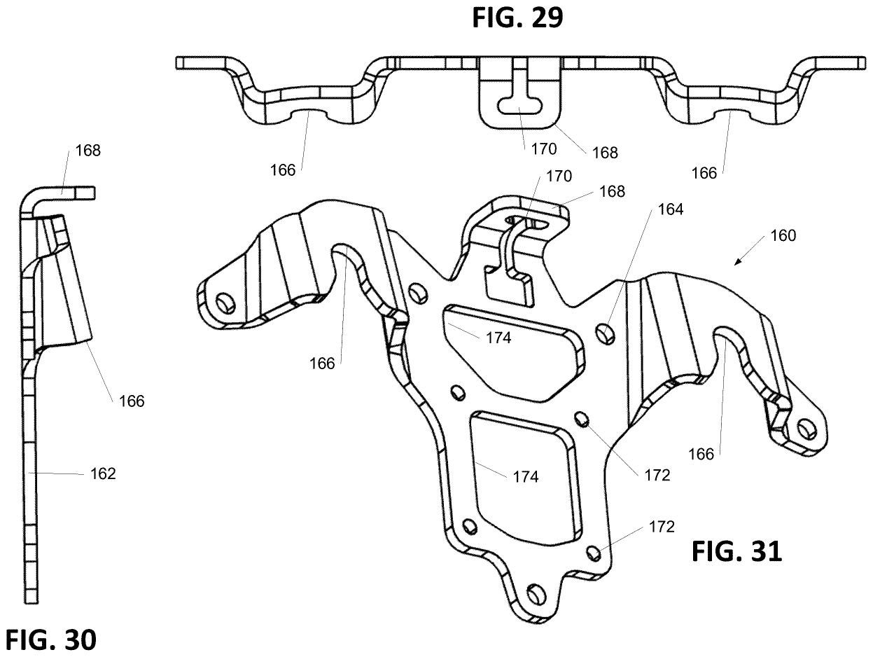

The bag mount assembly 108 includes a support 160 and a latch assembly 176, which together facilitate secure attachment of the forward-facing bag assembly 102 or aft-facing bag assembly 110 to the clamp mount assembly 116. With reference to FIGS. 29-31, various views of the support 160 are depicted. The support 160 includes a substantially planar body portion 162, which may be constructed from a unitary piece of material, such as an aluminum plate formed to achieve the necessary contours. Various bends can be incorporated into the planar body portion 162 to define specific structural features. The support 160 further defines fastener apertures 164, which are configured to receive fasteners 126, 150 extending from the base panel 118, 142, for example, via nuts, washers, or other suitable fasteners.

In some embodiments, the support 160 includes one or more supporting surfaces 166 (e.g., a pair of hangers) configured to operably couple to one or more lugs 195 extending from the clamp mount assembly 116. The planar body portion 162 may remain substantially planar, while the supporting surfaces 166 extend outwardly at an angle to enhance engagement with the lugs 195. Additionally, the support 160 defines a latch handle aperture 170 through which a latch handle 186 can extend. In some embodiments, the latch handle aperture 170 is positioned on a latch handle tab 168, which can be bent approximately 90° relative to the planar body portion 162 to improve ergonomics and functionality. The support 160 can further include latch assembly apertures 172 for secure attachment of the latch assembly 176, as well as one or more material cutouts 174 to reduce material usage and overall weight.

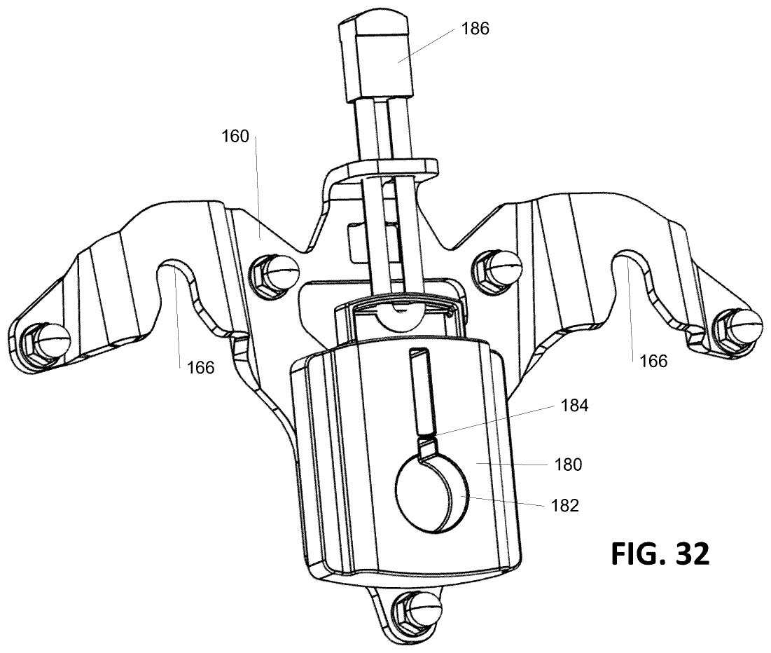

With reference to FIG. 28, the coupling of the latch assembly 176 to the support 160 is depicted, illustrating the relationship between these components. As depicted, the latch assembly 176 can be secured to the support 160 via one or more fasteners 178 (e.g., four fasteners). FIG. 32 provides a view of the fully assembled bag mount assembly 108. The latch assembly 176 includes a latch assembly body 180, which houses a movable latch 184 and an associated latch handle 186. The latch assembly body 180 further defines a latch post aperture 182, which is shaped and sized to receive a latch post 197 extending from the clamp mount assembly 116, thereby facilitating secure engagement between the bag mount assembly 108 and the clamp mount assembly 116. The latch handle 186 is configured to enable manipulation of the movable latch 184 to engage or disengage from a securing feature on the clamp mount assembly 116.

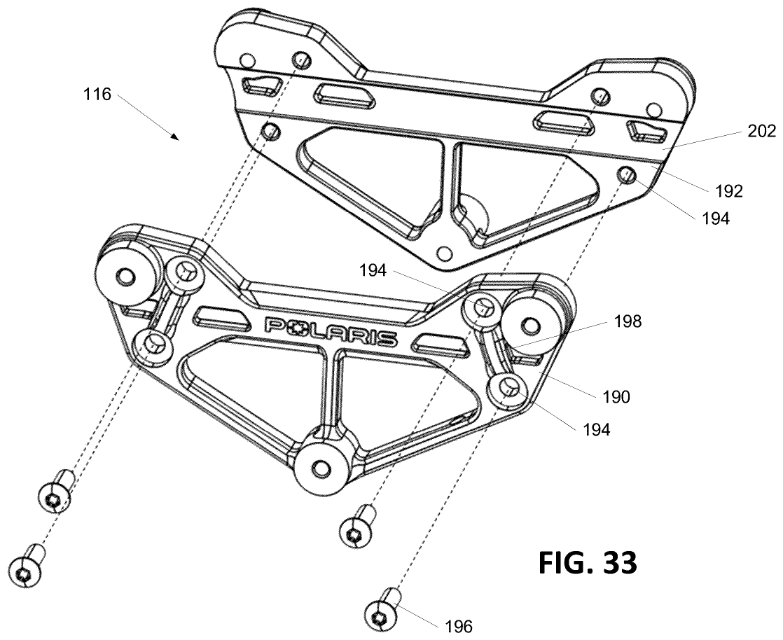

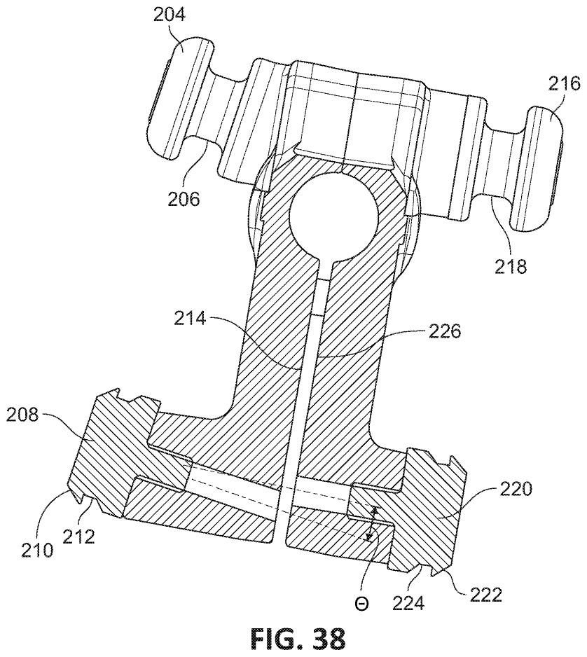

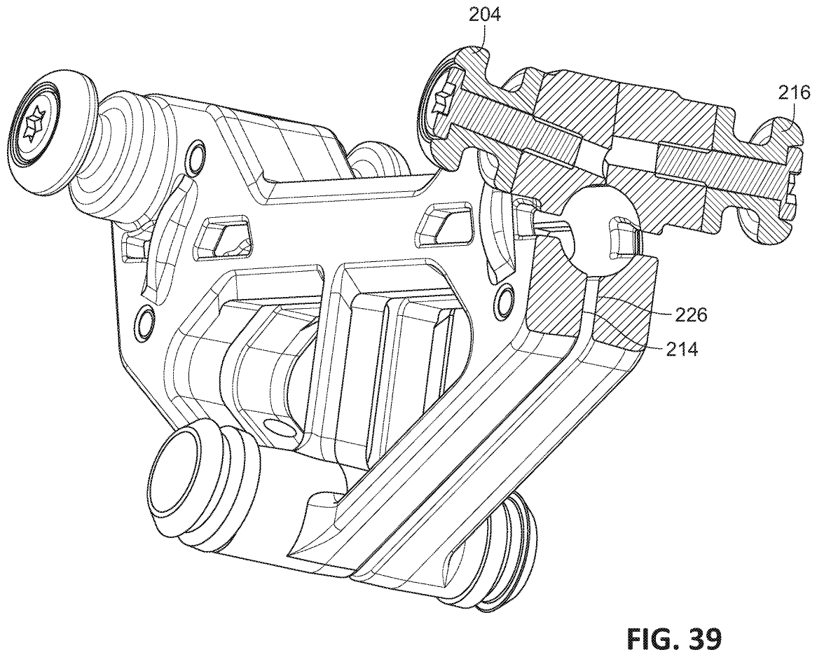

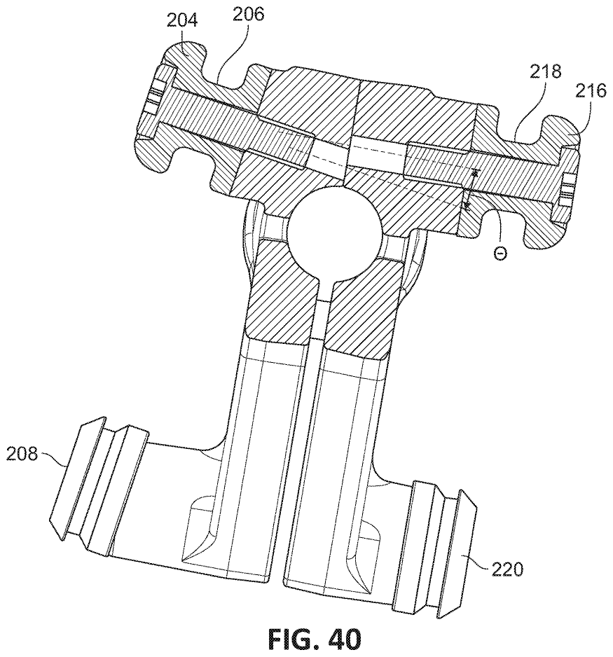

With reference to FIGS. 33-41, a clamp mount assembly 116 is illustrated. The clamp mount assembly 116 is configured to couple to a steering yoke or handlebars of a snowmobile 10 or another suitable vehicle, providing a secure mounting interface for the bag mount assemblies 108, 114, and thereby facilitating attachment of the mounted storage bag system 100.

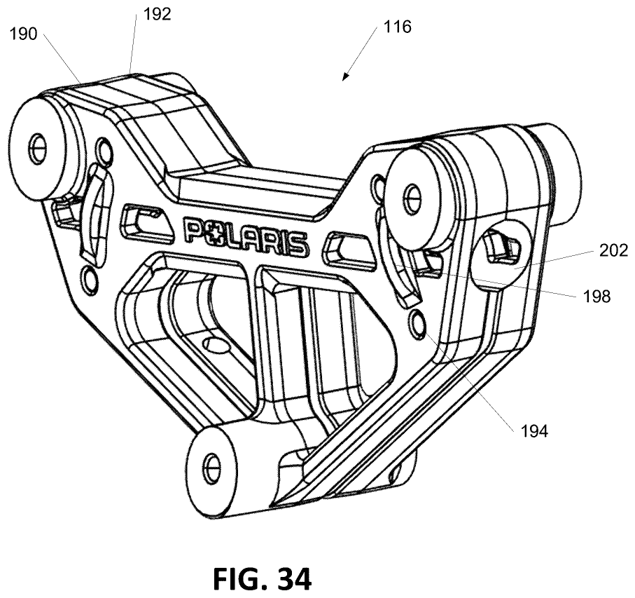

With particular reference to FIGS. 33-34, the clamp mount assembly 116 can include a first component 190 and a second component 192, which can be configured to sandwich a portion of the handlebars therebetween. Each of the first component 190 and the second component 192 defines a portion of a channel 202, which is shaped and sized to correspondingly receive a portion of the handlebar, thereby clamping the handlebar between the components when assembled. Additionally, both the first component 190 and the second component 192 define a plurality of apertures 194 (e.g., four apertures), through which fasteners 196 (e.g., four fasteners) can pass, thereby securing the first component 190 to the second component 192 and clamping the handlebar within the channel 202.

In some embodiments, the clamp mount assembly 116 further includes a structural reinforcement 198, which may comprise an additional material section positioned between adjacent apertures 194. As depicted, the structural reinforcement 198 can be formed as a protruding arch extending outwardly from either the first component 190 or the second component 192 to improve force distribution of the fasteners 196 across the handlebar.

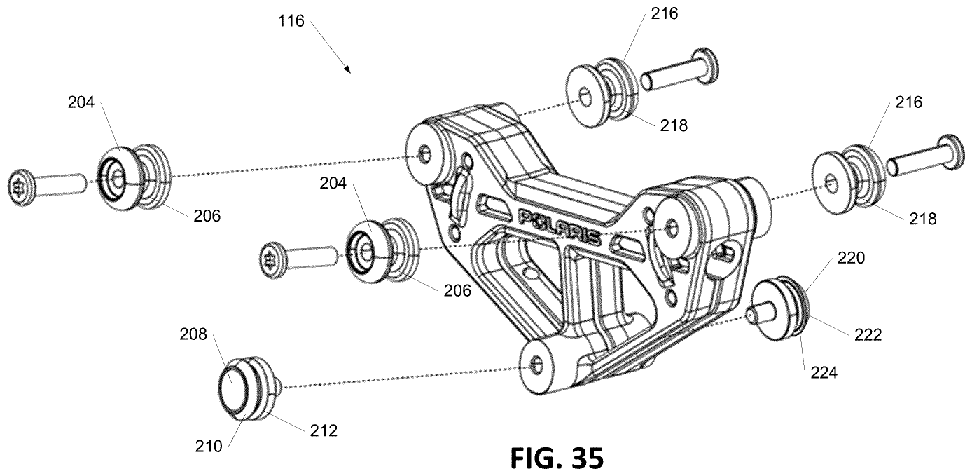

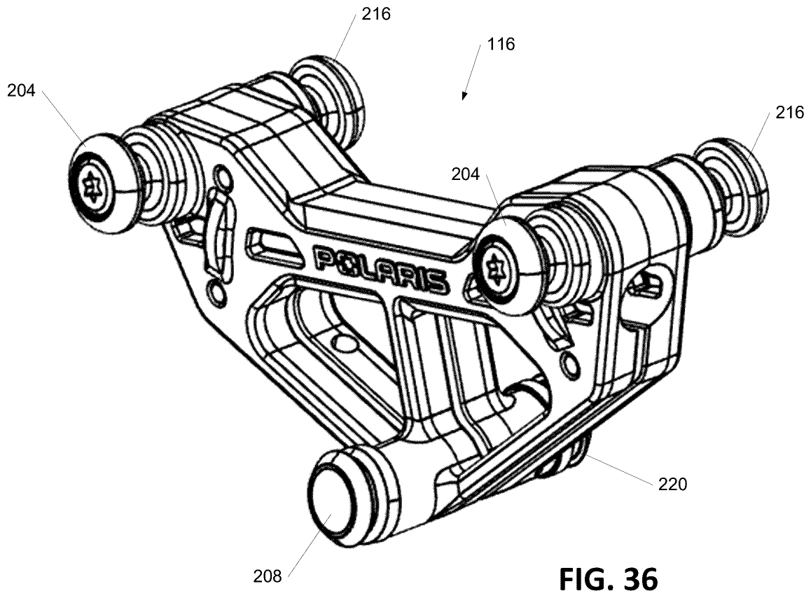

The first component 190 and the second component 192 define substantially planar abutting surfaces 214, 226, which face one another when the components are secured together via fasteners 196. With particular reference to FIGS. 35-36, each of the first component 190 and the second component 192 can include one or more lugs 204, 216 (e.g., two lugs) and one or more latch posts 208, 220 (e.g., a single latch post).

As depicted, the first component 190 can include lugs 204 and a latch post 208, which extend outwardly from the first component 190, generally away from the abutting surface 214. Each of the lugs 204 can define a ridge 206 configured to engage with the supporting surfaces 166 of the bag mount assembly 108 associated with the forward-facing bag assembly 102. In some embodiments, the ridge 206 can be substantially larger than the supporting surfaces 166, providing an extended contact area that enables the user to easily hang the forward-facing bag assembly 102 onto the clamp mount assembly 116 before final securement. The enlarged ridge configuration allows the bag mount assembly 108 to rest in a stable intermediate position, thereby facilitating alignment and engagement with the latch post 208.

Additionally, the latch post 208 can feature a tapered end 210 shaped to be received within the latch post aperture 182 of the latch assembly 176. The latch post 208 can further define a latch ridge 212 configured to interact with the movable latch 184 of the latch assembly 176, thereby facilitating secure engagement and controlled release of the forward-facing bag assembly 102. In some embodiments, the lugs 204 can be constructed from a resilient plastic material, enabling the lugs 204 to undergo resilient deformation against the supporting surfaces 166 as the forward-facing bag assembly 102 is pivoted into engagement with the latch post 208. This resilient deformation can provide a snug, vibration-resistant fit, reducing potential rattling or movement of the bag assembly during vehicle operation.

Similarly, the second component 192 can include lugs 216 and a latch post 220, which extend outwardly from the second component 192, generally away from the abutting surface 226. Each of the lugs 216 can define a ridge 218 configured to engage with the supporting surfaces 166 of the bag mount assembly 114 associated with the aft-facing bag assembly 110. As with the ridge 206, the ridge 218 can be substantially larger than the supporting surfaces 166, facilitating ease of hanging the aft-facing bag assembly 110 onto the clamp mount assembly 116 prior to final securement.

The latch post 220 can feature a tapered end 222 configured to be received within the latch post aperture 182 of the latch assembly 176. The latch post 220 can further define a latch ridge 224, which interacts with the movable latch 184 of the latch assembly 176 to provide secure retention and controlled disengagement. In some embodiments, the lugs 216 can be formed from a resilient plastic material, allowing them to undergo elastic deformation as the aft-facing bag assembly 110 is pivoted into engagement with the latch post 220. This resilient deformation ensures firm contact between the supporting surfaces 166 and the lugs 216, further enhancing stability and minimizing unintended movement of the aft-facing bag assembly 110 when secured in place.

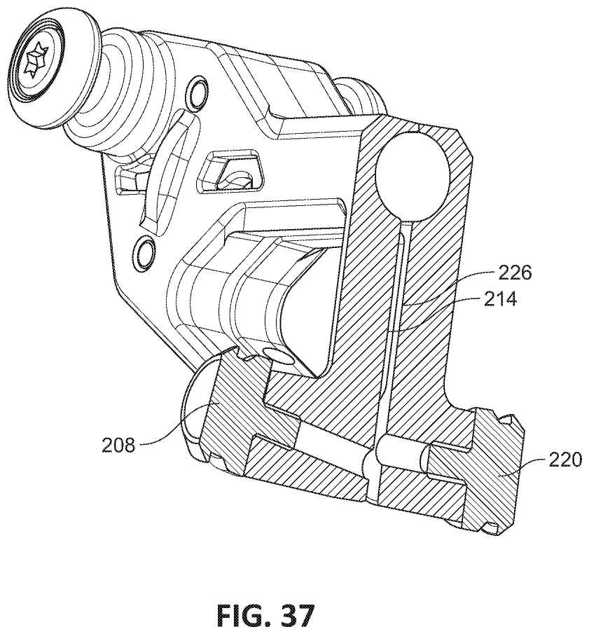

With reference to FIGS. 37-40, which depict cross-sectional views of the clamp mount assembly 116, further structural details of the first component 190 and the second component 192 are illustrated. Each of the first component 190 and the second component 192 can be distinct, with variations in the orientation of their respective lugs and latch posts to facilitate optimized engagement with the bag mount assemblies 108, 114.

In particular, the lugs 216 and the latch post 220 of the second component 192 extend outwardly from the second component 192 at an angle substantially perpendicular to the abutting surface 226, enabling interaction with the bag mount assembly 114 of the aft-facing bag assembly 110. By contrast, the lugs 204 and the latch post 208 of the first component 190 extend outwardly from the second component 192 at an angle relative to the abutting surface 214 (e.g., a non-orthogonal angle), such that the latch post 208 extends farther outward than the latch post 220 and features a slightly upward tilt. In embodiments, a angular differentiation Θ between the lugs 204, 216 can enhance the alignment and engagement between the lugs 204, 216, the latch posts 208, 220, and the bag mount assemblies 108, 114.

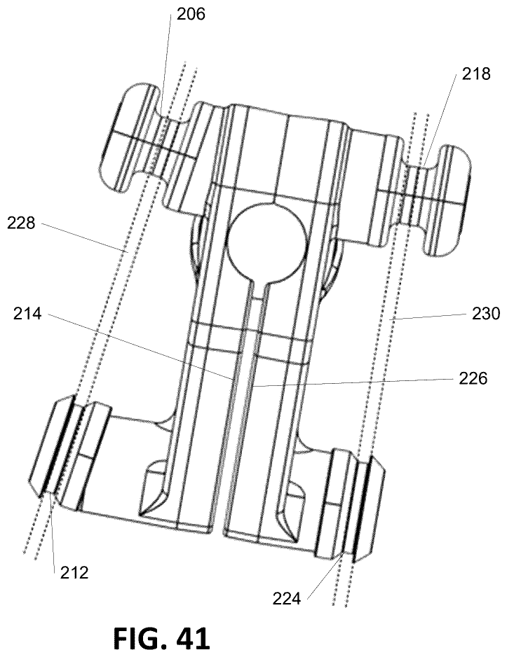

As further illustrated in FIG. 41, the ridge 206 of the lugs 204 aligns with the latch ridge 212 of the latch post 208 along a common plane 228, while the ridge 218 of the lugs 216 aligns with the latch ridge 224 of the latch post 220 along a distinct in particular, the common plane 230. The planes 228 and 230 are oriented at an angle Θ relative to one another, reflecting the differing configurations of the first component 190 and the second component 192.

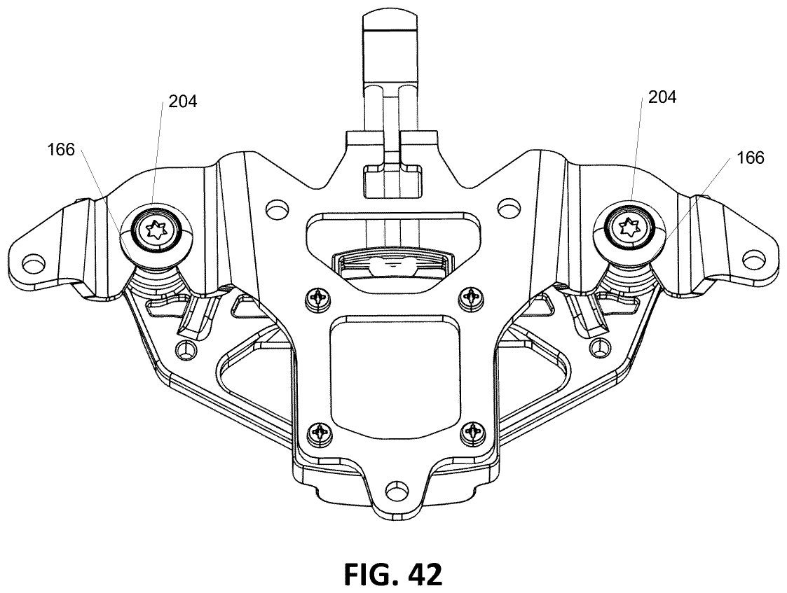

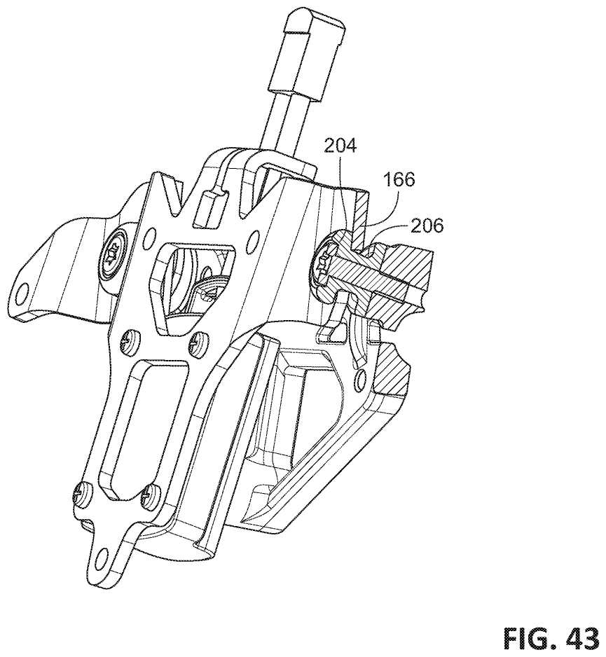

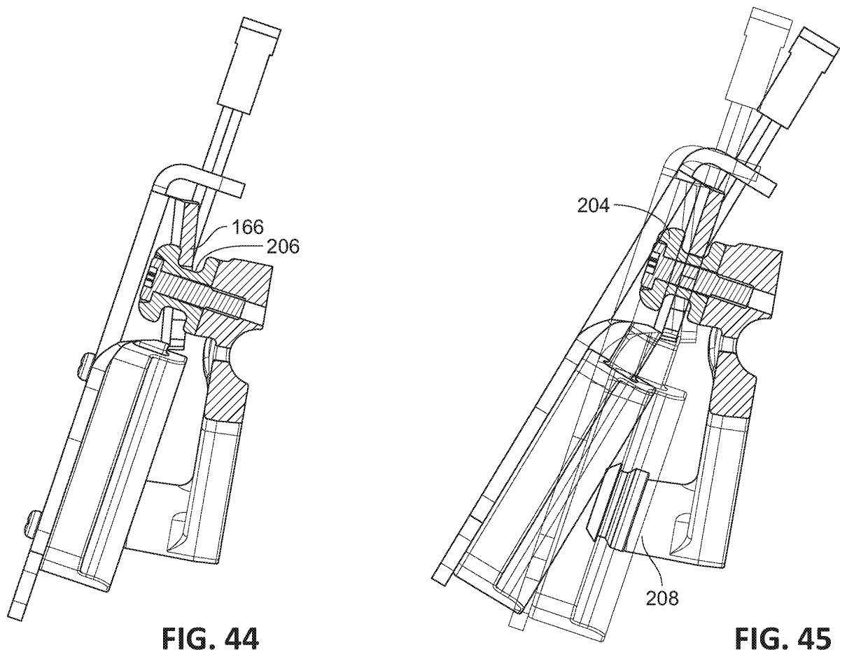

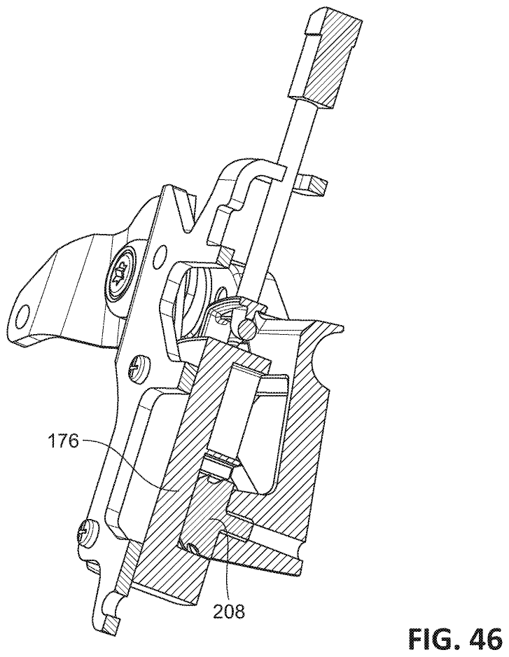

With initial reference to FIGS. 42-50, the interaction between the bag mount assemblies 108, 114 and the clamp mount assembly 116 is illustrated. The bag mount assemblies 108, 114 facilitate attachment of the forward-facing bag assembly 102 and the aft-facing bag assembly 110, respectively, to the clamp mount assembly 116, ensuring a secure yet detachable connection.

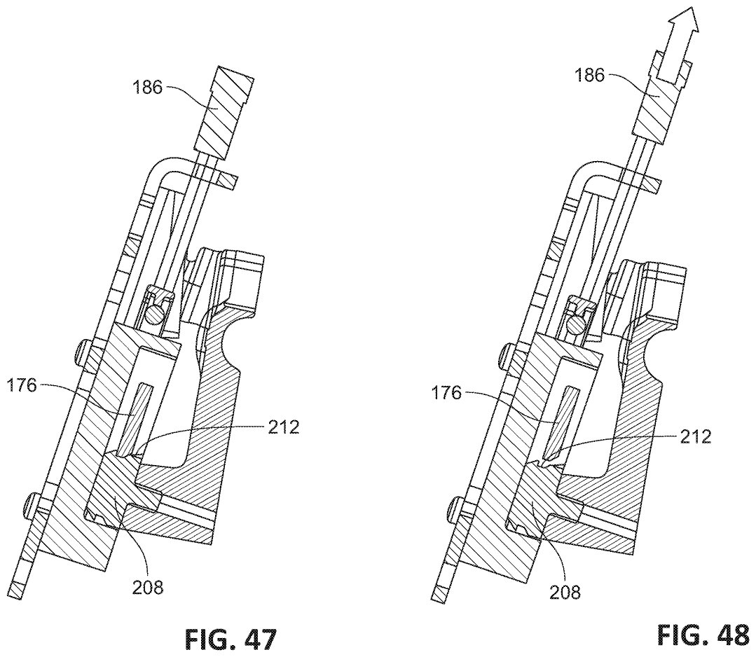

With particular reference to FIGS. 42-45, each of the lugs 204 of the clamp mount assembly 116 can be substantially cylindrical and can define a ridge 206, within which a corresponding supporting surface 166 of the support 160 can be positioned. The ridge 206 can be formed as a channel at least partially circumscribing the lug 204, such that the supporting surface 166 resides within the ridge 206 and contacts the lug 204 along an arc. This configuration enables the supporting surfaces 166 to pivot on the lugs 204 between a latch post engaging position (as depicted in FIG. 47) and a latch post disengaged position (as depicted in FIG. 48). In some embodiments, the lugs 204 can be formed from a resilient plastic material, allowing them to undergo elastic deformation as the bag assembly is pivoted into engagement with the latch post. This resilient deformation ensures firm contact between the supporting surfaces 166 and the lugs 204. The elasticity of the lugs 204 can compensate for minor variations in alignment during mounting, facilitating smooth engagement while maintaining a snug, vibration-resistant fit.

With further reference to FIGS. 47-48, the latch post 208 includes a tapered end 210, which facilitates guided insertion of the latch post 208 into the latch post aperture 182 of the latch assembly 176. The latch post 208 can be substantially cylindrical and defines a latch ridge 224, which is formed as a channel at least partially circumscribing the latch post 208, such that the movable latch 184 can engage or be seated within the latch ridge 224 and contacts the latch post 208 along an arc. In some embodiments, the latch post 208 or a portion of the latch assembly 176 can be magnetic, such that the latch post 208 is naturally pulled into the latch post aperture 182 of the latch assembly 176, facilitating automatic alignment and engagement without requiring precise manual positioning.

Further details regarding the latch post 208 and the latch assembly 176, including exemplary automatic magnetic engagement mechanisms, can be found in U.S. patent application Ser. No. 14/618,436 (now U.S. Pat. No. 9,555,935) assigned to Fidlock GmbH, the contents of which are incorporated by reference herein to the extent the reference does not conflict with the teachings herein.

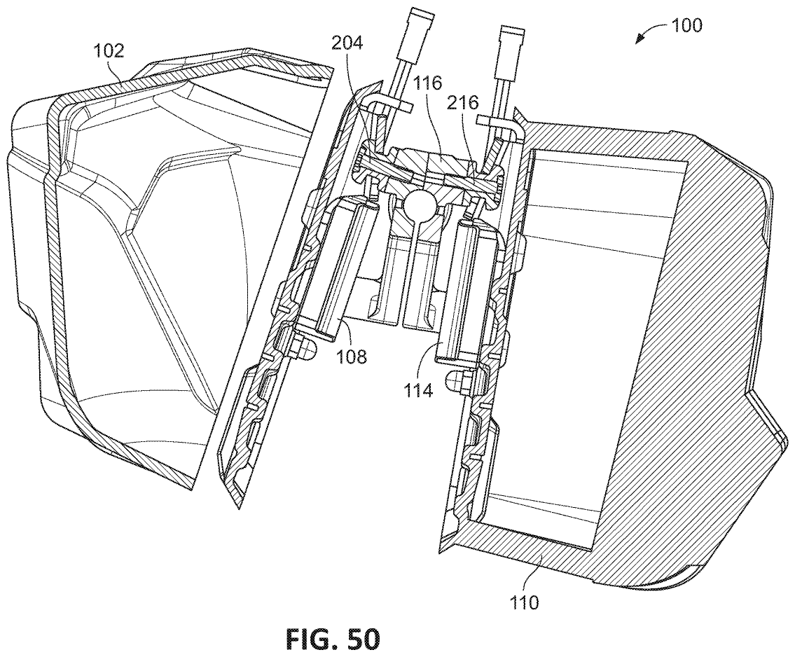

In embodiments, the movable latch 184 can be normally biased (e.g., via a spring or other biasing mechanism) to a latched position (as depicted in FIG. 50), thereby enabling automatic latching of the latch assembly 176 to the latch post 208 upon insertion into the latch post aperture 182. The movable latch 184 can be configured to momentarily move against the bias to accommodate insertion of the latch post 208, returning to its latched position once engagement is complete. The latch handle 186 is configured to manipulate the movable latch 184, allowing for controlled disengagement of the bag mount assembly 108 from the clamp mount assembly 116. In one embodiment, the latch handle 186 may be in the form of a pull cord, enabling quick-release functionality by pulling the cord to release the bag assembly from the lugs 204.

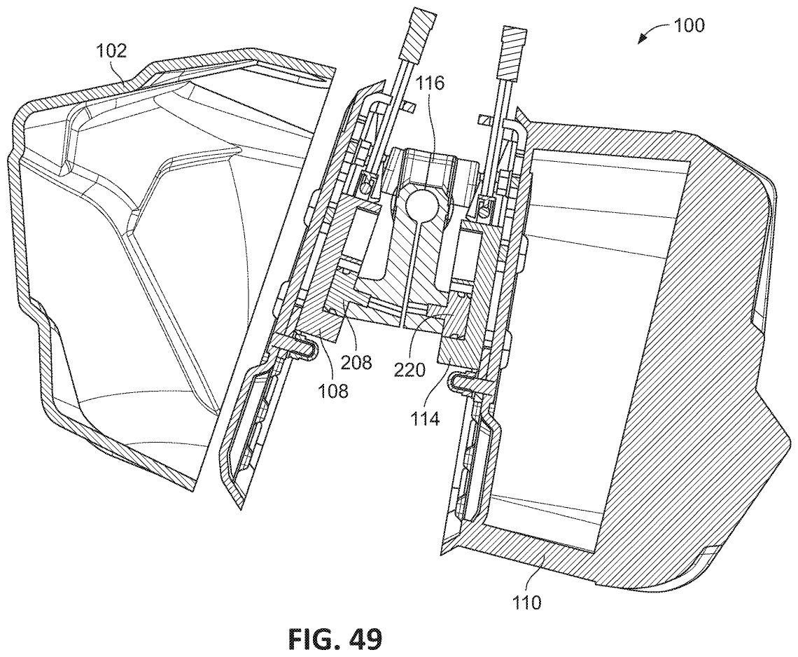

The above description regarding the interaction of the clamp mount assembly 116 with the bag mount assembly 108 of the forward-facing bag assembly 102 applies equally to the interaction between the clamp mount assembly 116 and the bag mount assembly 114 of the aft-facing bag assembly 110. With reference to FIGS. 49-50, the connection of both the forward-facing bag assembly 102 and the aft-facing bag assembly 110 to the clamp mount assembly 116 is depicted, illustrating the engagement of their respective bag mount assemblies 108, 114 to the lugs 204, 216 and latch posts 208, 220 of the clamp mount assembly 116.

In operation, a user can position the mounted storage bag system 100, including either the forward-facing bag assembly 102 or the aft-facing bag assembly 110, onto the lugs 204, 216 of the clamp mount assembly 116. When initially placed on the lugs 204, 216, the mounted storage bag system 100 is supported in a manner that allows it to pivot slightly, with the supporting surface 166 of the support 160 residing within the ridges 206, 218 of the respective lugs 204, 216. This engagement ensures that the mounted storage bag system 100 is positioned in a stable resting configuration before final securement.

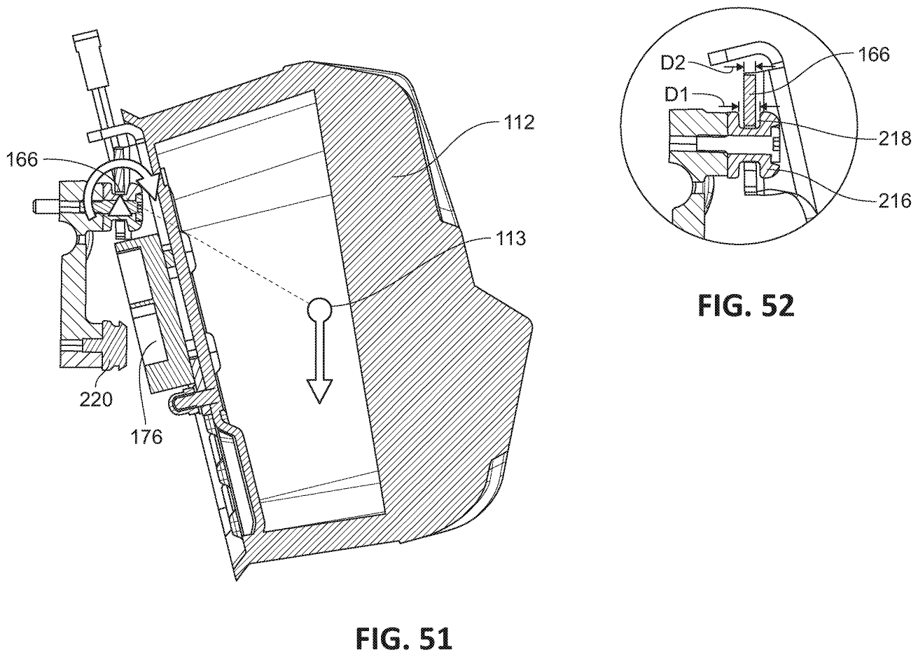

With reference to FIG. 51, in this position, the supporting surfaces 166 of the aft-facing bag 112 rest on the lugs 216, wherein the lugs 216 serve as a pivot point. The center of gravity 113 of the aft-facing bag 112 creates a moment arm about the supporting surfaces 166, causing the aft-facing bag 112 to rotate into contact with the latch post 220. This controlled pivoting action facilitates precise alignment between the latch post 220 and the latch post aperture 182 of the latch assembly 176, ensuring secure engagement. In some embodiments, magnetic force between the latch post 220 and the latch assembly 176 aids in alignment by pulling the latch post into the latch assembly, further reducing the need for precise manual positioning and enhancing engagement reliability.

With reference to FIG. 52, the dimension D1 of the ridge 216 can be between about 1.25 to 3 times larger than a cross-sectional thickness D2 of the supporting surfaces 166. This dimensional relationship enables the aft-facing bag 112 to be easily positioned on the lugs 216, providing a stable initial resting point before final securement. The increased ridge size further assists in alignment, ensuring the bag naturally settles into place. In embodiments where magnetic force is utilized, the magnetized latch post 220 may experience an attractive force toward the latch assembly 176, further aiding in alignment and engagement as the bag pivots into place.

Once positioned, the mounted storage bag system 100 can be pivoted forward or rearward, guiding the latch post 220 into the latch post aperture 182 of the latch assembly 176. As the latch post 220 is inserted, the movable latch 184 automatically engages the latch ridge 224, thereby securing the mounted storage bag system 100 in the latched position. In embodiments incorporating magnetic force, the magnetized latch post 220 is drawn into the latch post aperture 182, facilitating automatic alignment and engagement, thereby enhancing the ease of use.

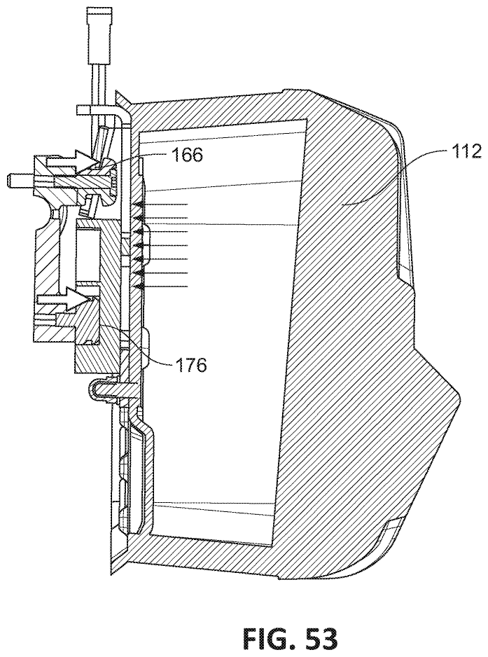

With reference to FIG. 53, the latch post 220 is shown received within the latch assembly 176. In some embodiments, the weight of the bag alone will cause the latch post 220 to be naturally guided into the latch assembly 176, facilitating automatic securement upon proper positioning of the bag. However, in other embodiments, it may be necessary to apply an external force to the bag assembly to ensure that the latch post 220 is fully seated within the latch assembly 176. This external force can generate a bending load on the bag mount assembly 108, 114 as the user presses the bag downward or pivots it into place, ensuring firm engagement. In embodiments incorporating a magnetized latch post 220, the magnetic attraction assists in pulling the latch post into the latch assembly, reducing the need for external force and minimizing potential misalignment.

The engagement of the latch post 208, 220 within the latch assembly 176 can be accompanied by an audible click, which provides the user with a positive indication of securement. The audible feedback is sufficiently distinct to be heard through a helmet, ensuring clear confirmation of engagement. Additionally, the securement process generates haptic feedback, such as a resistance threshold followed by a tactile release, further informing the user that the bag has been fully locked in place. In embodiments utilizing magnetic force, the latch post 220 may continue to be pulled toward the latch assembly 176 even after initial engagement, ensuring firm, wiggle-free securement.

Once locked in place, the mounted storage bag system 100 is retained in a pre-loaded position against the support 140. This pre-load configuration ensures a wiggle-free fit between the forward-facing bag, the aft-facing bag, and the clamp mount assembly 116, effectively eliminating unintended movement of the bag during vehicle operation. The pre-load fit also improves structural stability by reducing potential vibration-induced wear and noise while riding. The use of magnetic engagement further enhances securement by ensuring consistent positioning of the latch post 220 within the latch assembly 176.

In embodiments where external force is applied to facilitate latch engagement, the bag mount assembly 108, 114 may remain in a loaded state after securement. When the latch assembly 176 is subsequently released, the stored preloaded force within the bag mount assembly 108, 114 can cause it to return to its original, unloaded state, thereby facilitating the separation of the latch post 220 from the latch assembly 176. This elastic return action assists in controlled detachment by slightly lifting or displacing the bag assembly, making it easier for the user to disengage the bag from the mounting system. In magnetized embodiments, releasing the latch assembly 176 can counteract the magnetic force, ensuring smooth separation of the latch post 220 from the latch assembly 176.

To remove the mounted storage bag system 100, the user actuates the latch handle 186, which manipulates the movable latch 184 to disengage from the latch ridge 224, thereby releasing the latch post 208, 220 from the latch post aperture 182. Upon release, the mounted storage bag system 100 is free to pivot slightly on the lugs 204, 216, facilitating controlled detachment. The user can then fully remove the mounted storage bag system 100 from the snowmobile 10 by lifting it off the lugs 204, 216, thereby disengaging the supporting surface 166 from the ridges 206, 218 and fully detaching the support 160 from the clamp mount assembly 116. In magnetized configurations, the release action may include overcoming the residual magnetic attraction, ensuring smooth detachment without excessive resistance.

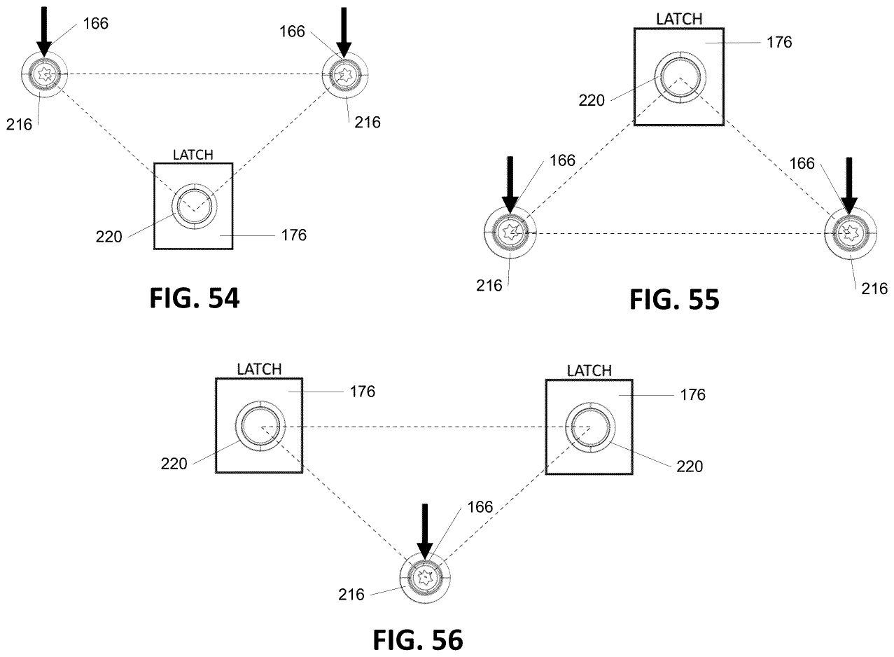

With reference to FIG. 54, a first configuration of the bag mount assemblies 108, 114 is depicted, which corresponds generally to the arrangement shown in FIGS. 7-52. In this configuration, a pair of supporting surfaces 166 is positioned above the latch assembly 176, enabling the bag assembly to hang from the supporting surfaces 166 while being pivotally engaged with the latch post 220. This hanging configuration allows for controlled engagement and disengagement, as the bag naturally pivots about the supporting surfaces 166 before final securement within the latch assembly 176.

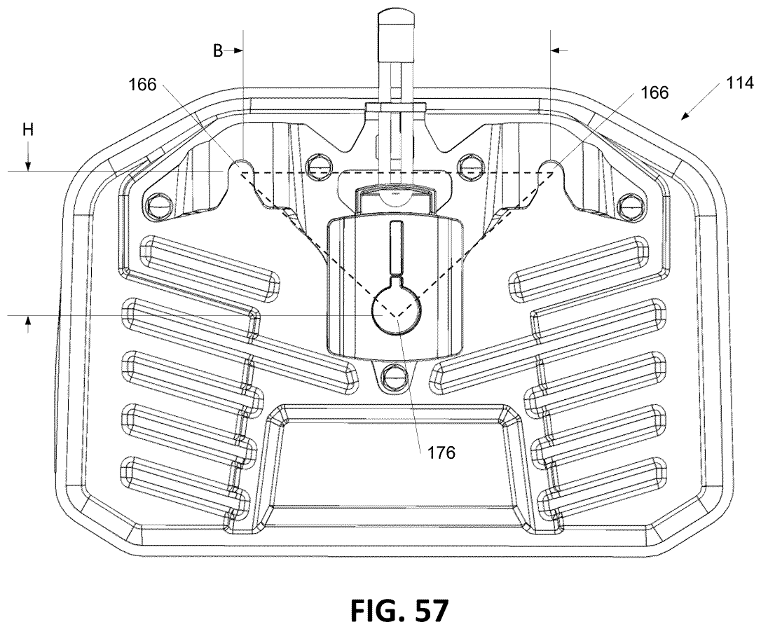

FIG. 57 illustrates an embodiment of the bag mount assembly 114, which corresponds to the arrangement of the lugs 216 and latch post 220 depicted in FIG. 54. In this configuration, the lugs 216 and latch post 220 are arranged in a triangular orientation, with either a lug 216 or the latch post 220 positioned at each vertex of the triangle.

In one embodiment, the triangle is an isosceles triangle having a base length B and a height H, where the lugs 216 are positioned along the base length B, and the latch post 220 is centered below the lugs at a distance H beneath the base. The base length B can range between about 3 inches (about 7.6 cm) and about 9 inches (about 22.9 cm), with one example placing the pair of supporting surfaces at a base length of between about 4.25 inches (about 10.8 cm) and about 4.75 inches (about 12.1 cm) apart. The height H can range between about 2 inches (about 5.1 cm) and about 8 inches (about 20.3 cm), and in one embodiment, the latch assembly is positioned about 1.75 to 2.25 inches (about 4.4 to 5.7 cm) below the pair of supporting surfaces, forming an isosceles triangle with a base length of between about 4.25 inches (about 10.8 cm) and about 4.75 inches (about 12.1 cm) and a height of about 1.75 inches to about 2.25 inches (about 4.4 cm to about 5.7 cm).

In another embodiment, the isosceles triangle has a base length of approximately 4.5 inches (approximately 11.4 cm) and a height of approximately 2 inches (approximately 5.1 cm), providing a balanced and stable structure. Further, in one embodiment, the base length B is between about 1.8 to about 2.7 times the height H, ensuring stability and secure engagement. The triangular configuration facilitates a balanced distribution of forces, with the latch post 220 positioned centrally to maintain structural integrity and engagement reliability. The positioning of the lugs 216 along the base enhances lateral stability, while the vertical offset of the latch post 220 contributes to a secure locking mechanism. Additionally, the triangular orientation helps accommodate variations in load distribution, ensuring the assembly remains robust under different operating conditions.

In the embodiment shown in FIG. 57, the bag mount assembly 114 functions as a bag interface, configured to interface with the mounting interface of the clamp mount assembly 116. In some embodiments, the supporting surfaces 166 can be configured as slots or channels for receiving the lugs 216 in a first direction (e.g., as the bag is positioned onto the lugs 216, the lugs slide into the channels or slots defining the supporting surfaces 166). Once positioned, the bag then moves in a second direction, transverse to the first direction, as the latch post 220 is received within the latch assembly 176. This two-step engagement process ensures secure attachment while minimizing unintended movement during initial positioning.

Furthermore, in some embodiments, a magnetic force between the latch post 220 and the latch assembly 176 can aid in alignment by pulling the latch post into the latch assembly 176 during the final phase of securement. This magnetic attraction reduces the need for precise manual alignment, ensuring that the latch post 220 is effectively guided into the latch post aperture 182. Additionally, the magnetic force enhances retention of the bag assembly, providing an additional level of securement and vibration resistance while allowing for quick and intuitive detachment when needed.

Alternatively, as depicted in FIG. 55, the supporting surfaces 166 can be positioned along the bottom of the bag mount assemblies 108, 114. In this alternative configuration, the latch assembly 176 is configured to pivot into contact with the latch post 220, rather than the bag pivoting downward into place. This arrangement modifies the pivoting mechanics, such that the latch assembly 176 moves relative to the latch post 220, providing a secure engagement mechanism that may be preferable for certain mounting orientations.

As further depicted in FIG. 56, in some embodiments, the bag mount assembly 108, 114 may include only a single supporting surface 166. In such an embodiment, the single supporting surface 166 facilitates pivoting of the bag assembly in a manner that enables the simultaneous receipt of a pair of latch posts 220 within a corresponding pair of latch assemblies 176. This single-support configuration provides an alternative engagement method, where the bag assembly is guided into position using a single pivot point before being securely latched.

Other configurations and variations are also contemplated, including modifications to the positioning, number, or structure of the supporting surfaces 166, latch posts 220, and latch assemblies 176 to accommodate different vehicle geometries, user preferences, or operational requirements. The triangular orientation of the lugs 216 and latch post 220, as exemplified in FIG. 57, provides a versatile framework for stable engagement, particularly in embodiments utilizing magnetic alignment for securement assistance.

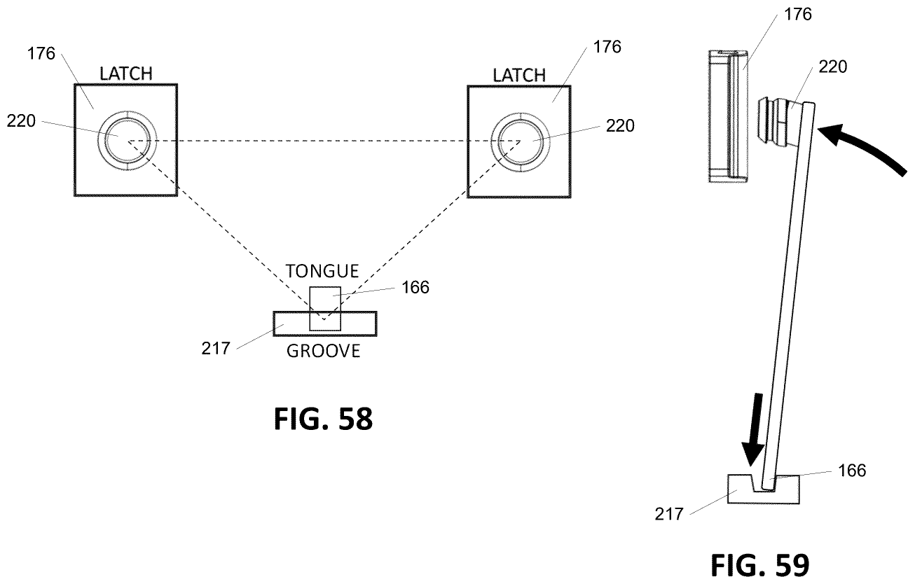

With reference to FIGS. 58 and 59, a fourth configuration of the bag mount assembly 108, 114 is depicted. Similar to the configuration illustrated in FIG. 56, the fourth configuration incorporates a pair of latch assemblies 176, each configured to receive a corresponding latch post 220. However, in contrast to prior embodiments that utilize lugs 216 to provide pivotal support, the fourth configuration defines a groove 217 in place of the lugs 216. The groove 217 is structured to receive a corresponding supporting surface 166, wherein the supporting surface 166 extends in the form of a tongue, thereby forming a tongue-and-groove interface.

FIG. 59 illustrates the interaction between the supporting surface 166 and the groove 217, wherein the supporting surface 166 is received within the groove 217, enabling the bag mount assembly 108, 114 to pivot for proper alignment and engagement with the latch post 220. The tongue-and-groove interface facilitates ease of assembly by guiding the supporting surface 166 into a constrained, yet accommodating, position prior to final securement within the latch assembly 176.

In certain embodiments, an alternative configuration includes a pair of tongue-shaped supporting surfaces 166 positioned along the base length B of a triangle, with a single latch assembly 176 centered above and positioned at a height H relative to the base length B. This alternative arrangement enables the supporting surfaces 166 to engage corresponding grooves 217 along the base, permitting pivoting movement for secure engagement of the latch post 220 within the latch assembly 176.

As with other embodiments, the groove 217 can be dimensioned to be relatively larger compared to the thickness of the supporting surface 166. This dimensional relationship allows for ease of insertion, enabling the supporting surface 166 to be readily received within the groove 217. Once inserted, the supporting surface 166 can shift within the groove 217 into abutting contact with a lateral edge of the groove 217, particularly in embodiments where the bag mount assembly 108, 114 maintains a slight bend or pre-stress. The pre-stress condition ensures a snug fit upon securement of the latch post 220 within the latch assembly 176, reducing unintended movement and improving overall retention.

Additionally, similar to previous configurations, a magnetic force between the latch post 220 and the latch assembly 176 can aid in alignment, pulling the latch post 220 into the latch assembly 176 during the final phase of engagement. The magnetic attraction provides an additional level of positioning assistance, ensuring that the latch post 220 is guided into the latch post aperture 182 with minimal manual adjustment. This magnetic interaction further enhances retention, mitigating vibrations and securing the bag assembly against inadvertent displacement during vehicle operation.

Other variations and modifications of the fourth configuration are also contemplated. For instance, the groove 217 can be implemented as a continuous slot extending along a lateral edge of the bag mount assembly 108, 114, enabling variable positioning of the supporting surface 166 within the groove. Additionally, the groove 217 may include a tapered or chamfered lead-in to facilitate easier alignment of the supporting surface 166 upon initial engagement. The triangular orientation of the supporting surfaces 166 and the latch post 220 in FIGS. 58 and 59 further ensures a stable, balanced mounting interface, particularly when combined with magnetic alignment features.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A mounted storage bag system, comprising:
a mount assembly comprising at least one lug and a latch post extending outwardly therefrom; and
a bag assembly including at least one supporting surface configured to engage the at least one lug of the mount assembly, and a latch assembly configured to receive the latch post of the mount assembly, wherein the at least one supporting surface is configured to rest on the at least one lug enabling the bag assembly to pivot relative to the mount assembly to enabling selective receipt of the latch post by the latch assembly.

2. The mounted storage bag system of claim 1, wherein the latch assembly comprises a movable latch biased to a latched position, the movable latch configured to engage a latch ridge defined by the latch post when the latch post is received within the latch assembly.

3. The mounted storage bag system of claim 2, wherein the movable latch is biased by a spring mechanism, such that the movable latch automatically engages the latch ridge upon insertion of the latch post into the latch assembly.

4-6. (canceled)

7. The mounted storage bag system of claim 1, wherein the at least one supporting surface is configured to rest within a ridge defined on the at least one lug.

8. The mounted storage bag system of claim 7, wherein the ridge is formed as a channel at least partially circumscribing the at least one lug, such that the at least one supporting surface contacts the at least one lug along an arc and allows pivotal movement of the bag assembly relative to the mount assembly.

9. The mounted storage bag system of claim 7, wherein the ridge has a width between about 1.5 to 3 times larger than a corresponding depth or thickness of the at least one supporting surface, thereby facilitating ease of positioning of the at least one supporting surface on the at least one lug while allowing the at least one supporting surface to shift within the ridge, such that upon receipt of the latch post within the latch assembly, the at least one supporting surface moves into abutting contact with surfaces of the ridge to create a snug fit and inhibit unintended movement of the bag assembly during operation.

10. The mounted storage bag system of claim 1, wherein the latch post includes a tapered end, the tapered end configured to guide the latch post into the latch assembly during pivoting movement of the bag assembly toward a latched position.

11. The mounted storage bag system of claim 1, further comprising a latch handle operably coupled to a movable latch, wherein actuation of the latch handle enables release of the movable latch from the latch post, thereby allowing removal of the bag assembly from the mount assembly.

12. The mounted storage bag system of claim 11, wherein the latch handle comprises a pull cord, wherein pulling the pull cord actuates the movable latch to release the latch post from the latch assembly, allowing detachment of the bag assembly from the mount assembly.

13. The mounted storage bag system of claim 1, wherein the latch post or a portion of the latch assembly is magnetic, such that the latch post is magnetically drawn into the latch assembly upon pivoting movement of the bag assembly toward a latched position.

14-22. (canceled)

23. A clamp mount assembly for securing a bag assembly to a vehicle, comprising:
a first component defining a forward-facing mounting interface, the forward-facing mounting interface including a first pair of lugs extending outwardly from the first component, and a first latch post positioned beneath the first pair of lugs, wherein the first pair of lugs and the first latch post define a triangular configuration, with the first pair of lugs positioned along a base of a triangle configuration and the first latch post positioned at a vertex beneath the base; and
a second component defining a rear-facing mounting interface, the rear-facing mounting interface including a second pair of lugs extending outwardly from the second component, and a second latch post positioned beneath the second pair of lugs, wherein the second pair of lugs and the second latch post define the triangular configuration, with the second pair of lugs positioned along the base of the triangle configuration and the second latch post positioned at the vertex beneath the base.

24. (canceled)

25. The clamp mount assembly of claim 23, wherein the first latch post and the second latch post each include a magnetically-attractive material.

26. The clamp mount assembly of claim 23, wherein each of the first latch post and the second latch post defines a tapered end.

27. The clamp mount assembly of claim 23, wherein each of the first pair of lugs and the second pair of lugs define slots or recesses configured to receive corresponding supporting surfaces of the bag assembly.

28. The clamp mount assembly of claim 23, wherein the first pair of lugs and second pairs of lugs are constructed from a resilient polymer material, enabling elastic deformation during pivoting engagement of the bag assembly to ensure a secure, vibration-resistant fit.

29-30. (canceled)

31. An accessory for mounting on an all-terrain vehicle, the accessory comprising:
a pair of supporting surfaces positioned at two corners of a base of an isosceles triangle;
a latch assembly positioned at a third angle of the isosceles triangle opposite the base; and
wherein the pair of supporting surfaces and the latch assembly define a triangular configuration, enabling the accessory to pivot on the pair of supporting surfaces before securement of the latch assembly.

32. The accessory of claim 31, wherein the pair of supporting surfaces are positioned a base length of between about 4.25 and 4.75 inches apart from one another.

33. The accessory of claim 31, wherein the latch assembly is positioned a distance of about 1.75 and 2.25 inches below the pair of supporting surfaces, forming the triangular configuration with a base length of between about 4.25 and 4.75 inches and a height of about 1.75 and 2.25 inches.

34. The accessory of claim 31, wherein the isosceles triangle has a base length of between about 4.25 and 4.75 and a height of between about 1.75 and 2.25 inches, with the base length being between about 1.8 and 2.7 times the height, providing stability and secure engagement.

35-38. (canceled)

39. The accessory of claim 31, further comprising a latch post, wherein the latch post and the latch assembly are magnetically attracted to one another, with a magnetic force aiding in alignment and pulling the latch post into the latch assembly during a final phase of engagement.
